(19) United States
(12) Patent Application Publication
(10) Pub. No.: US 2006/0166120 A1
(43) Pub. Date: Jul. 27, 2006

(54) Toner, image forming method, and process cartridge

(75) Inventors: Yuji Moriki, Numazu-shi (JP); Keiji Komoto, Numazu-shi (JP); Yasushi Katsuta, Sunto-gun (JP); Takeshi Kaburagi, Numazu-shi (JP); Tomoaki Igarashi, Numazu-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/315,332

(22) Filed: Dec. 23, 2005

(30) Foreign Application Priority Data
Jan. 26, 2005 (JP) 2005-017777 (PAT.

(51) Int. Cl. G03G 9/097

(52) U.S. Cl. 430/109.3; 430/111.4; 430/124

(57) ABSTRACT

In a toner having toner particles containing at least a binder resin, a colorant and a release agent, the toner has a loss tangent (tan δ) which has a minimum value 1 and a maximum value 1 at from 70° C. or more to less than 110° C. and has a maximum value 2 at from 140° C. or more to less than 200° C. and has a loss elastic modulus at 140° C., G″(140° C.), which is:
1.0×10⁴ dN/m2≦G″(140° C.)≦2.0×10⁵ dN/m²; and the binder resin is chiefly composed of a vinyl type copolymer. This can provide a toner with which images kept to have gloss within a preferable state can be obtained without changing fixing speed and fixing temperature even when transfer materials of different types are used.

### BACKGROUND OF THE INVENTION

1. Field of the Invention

This invention relates to a toner used in recording methods which utilize electrophotography, electrostatic recording or the like. This invention also relates to an image forming method and a process cartridge which utilize electrophotography, electrostatic recording or the like.

2. Related Background Art

In image forming apparatus in which stated latent images are formed on an electrostatic latent image bearing member such as a photosensitive drum and are made into visible images by using a toner, as in electrophotographic apparatus and electrostatic recording apparatus, the glossiness (gloss) of fixed images to be obtained may change depending on the type of transfer materials to be used. This is because the surface unevenness of a surface layer of a transfer material influences the surface smoothness of fixed toner images.

A case is found as well in which a transfer material having a smooth surface is used to obtain high-gloss images intentionally. However, many cases are also found in which a like gloss should hopefully be attained even when transfer materials having different surface properties are used. Such cases are exemplified by a case in which a document composed of regenerated paper and woodfree paper is prepared.

Here, as a means by which the gloss is controlled at any desired value, a method is usually available in which fixing speed and temperature are changed according to the type of paper (e.g., Japanese Patent Applications Laid-open No. 2003-028045 and No. 2004-094096). However, in many cases, this method makes it necessary to lower the fixing speed and/or raise the fixing temperature, and brings about problems from the viewpoint of usability and energy saving.

As other means by which the gloss is controlled at any desired value, a method is available in which maximum endothermic peak and molecular weight are prescribed and further a toner having a specific viscoelasticity is used, to obtain images having appropriate gloss in a broad temperature range (e.g., Japanese Patent Applications Laid-open No. 2001-075305 and No. 2004-151638). However, as a result of detailed studies made by the present inventors, it has been found difficult for the toners disclosed in these publications, to afford image gloss within a preferable range on transfer materials of any types when fixing is performed under the same fixing conditions. Thus, there has been room for further improvement.

### SUMMARY OF THE INVENTION

An object of the present invention is to provide a toner with which images kept to have gloss within a preferable range can be obtained without changing fixing speed and fixing temperature even when transfer materials of different types are used, and to provide an image forming method and a process cartridge which make use of such a toner.

To achieve the above object, the present invention is characterized by the following.

That is, what is characteristic of the present invention is to use a toner which is a toner comprising toner particles containing at least a binder resin, a colorant and a release agent;

the toner having a loss tangent (tan δ) which has a minimum value 1 and a maximum value 1 at from 70° C. or more to less than 110° C. and has a maximum value 2 at from 140° C. or more to less than 200° C.;

the toner having a loss elastic modulus at 140° C., G″(140° C.), which is:

1.0×10⁴ dN/m²≦G″(140° C.)≦2.0×10⁵ dN/m²; and

the binder resin being chiefly composed of a vinyl type copolymer.

### BRIEF DESCRIPTION OF THE DRAWINGS

FIG. 1 diagrammatically illustrates an image for evaluation, used in evaluation in the present invention.

FIG. 2 illustrates a toner layer control member in the image forming method of the present invention.

FIG. 3 schematically illustrates the construction of an example of an apparatus practicing the image forming method of the present invention.

FIG. 4 schematically illustrates the construction of another example of an apparatus practicing the image forming method of the present invention.

FIG. 5 schematically illustrates the construction of still another example of an apparatus practicing the image forming method of the present invention.

FIG. 6 schematically illustrates the construction of a further example of an apparatus practicing the image forming method of the present invention.

FIG. 7 schematically illustrates the construction of a still further example of an apparatus practicing the image forming method of the present invention.

FIG. 8 schematically illustrates the constitution of a still further example of an apparatus practicing the image forming method of the present invention.

FIG. 9 shows examples of storage elastic modulus G′ and loss elastic modulus G″ of the toner of the present invention.

FIG. 10 shows an example of loss tangent (tan δ) of the toner of the present invention.

### DESCRIPTION OF THE PREFERRED EMBODIMENTS

The reason why the present invention achieves the above effect is unclear, and is presumed as stated below.

In order to obtain images kept to have image gloss in a preferable state, without changing fixing conditions even when transfer materials of different types are used, toners are required to have, in their molten state, a good follow-up performance for the surface unevenness of a surface layer of a transfer material. This property correlates greatly with loss elastic modulus (hereinafter also referred to as G″), which is the value of physical properties that represents the viscosity of a toner. On the other hand, toners are also required to be, in their molten state, kept from offsetting to fixing members. This property correlates greatly with storage elastic modulus (hereinafter also referred to as G′), which is the value of physical properties that represents the elasticity of a toner.

Now, the amount of the heat to be lost by the transfer material at the time of fixing of toner images changes where the thickness of a transfer material changes. The amount of the heat to be lost by the transfer material at the time of fixing of toner images also changes where the transfer material has the same basis weight and a different quality of surface unevenness. This is presumably because the specific heat of air layers formed at gaps between the surface unevenness and the toner images is added. As the result, the total amount of the heat to be imparted to the toner images until the step of fixing is completed comes large or small depending on the type of, and the quality of surface unevenness, of the transfer material as long as fixing speed, fixing temperature, fixing pressure and so forth are set alike.

Thus, because of the foregoing, in order to keep a toner from offsetting to fixing members where transfer materials of different types are used under the same fixing conditions, it is necessary that the temperature dependence of G′ is made smaller than conventional one in the vicinity of the temperature at which the toner comes into a molten state. This is because, since the offset to fixing members occurs at the fixing step latter half at which the transfer material separates from the fixing members, the specific heat of the transfer material and that of the air layers must be taken into account.

As for the G″, where fixing conditions are set constant, the value of G″ at a specific temperature fitted to the fixing conditions may be so set as to be in a preferable range. The follow-up performance for the surface unevenness of the transfer material surface layer is concerned with the first half of the fixing step, it is unnecessary to take account of the specific heat of the transfer material. Hence, it is considered that attention may be directed only to the mutual action between the fixing members and the toner images and that the value of G″ at a certain specific temperature may be controlled.

As a result of extensive studies, the present inventors have discovered that the value of G″ of the toner at 140° C. must be set at from 1.0×10⁴ dN/m² or more and 2.0×10⁵ dN/m² or less.

If the toner has a loss elastic modulus at 140° C., G″(140° C.), of less than 1.0×10⁴ dN/m², although it can be a toner having a superior follow-up performance for the surface unevenness of the transfer material surface layer, images may result which have reflected the difference in gloss between transfer materials themselves, and hence the value of gloss can not be kept in a preferable range. If on the other hand the toner has a G″(140° C.) of more than 2.0×10 dN/m², it may be a toner having an inferior follow-up performance for the surface unevenness of the transfer material surface layer, and any images kept to have gloss in a preferable state are not obtainable when transfer materials of different types are used.

Incidentally, the temperature 140° C. is a suitable temperature on the basis of which discussion can be made in regard to the fixing performance of toners, taking account of fixing temperature and in addition thereto other parameters such as pressure at the time of fixing and fixing speed.

The toner according to the present invention is required to have a loss tangent (tan δ) which has a maximum value (maximum value 1) and a minimum value (minimum value 1) at from 70° C. or more to less than 110° C.; the loss tangent being the ratio of the loss elastic modulus G″ to the storage elastic modulus G′. Incidentally, the maximum value 1 appearing in the region of from 70° C. or more to less than 110° C. may preferably be the first maximum value of the curve of tans in the temperature range of from 40 to 200° C.

The maximum value 1 of tan δ in this temperature range is what corresponds to the temperature at which the binder resin transforms from the glassy state to the heat-deformable state, and suggests that the microbrownean movement of polymeric chains constituting the binder resin at that temperature stands activated.

The minimum value 1 of tan δ in this temperature range also shows that the binder resin is in the state that it readily flows and deforms at that temperature even when no force is applied from the outside, and suggests that a release component in the toner is kept ready to exude. Therefore, it is preferable that the temperature at which the tan δ attains the maximum value 1 is kept lower than the temperature at which the tan δ attains the minimum value 1.

If the temperature at which the tan δ attains the maximum value 1 is less than 70° C., toner particles may deform and break with ease because of the frictional heat coming between fixing members and developing members. Hence, although images of no problem are obtained as initial-stage images, the toner may have an inferior running performance, undesirably. Stated specifically, as a result of continuous printing, the images may no longer be those kept to have initial-stage gloss in a preferable state, and in addition thereto toner particles may adhere to (fog on) non-image areas, undesirably. If on the other hand the temperature at which the tan δ attains the minimum value 1 is more than 110° C., the release agent wax may not effectively exude to make insufficient the fixing of toner images to the transfer material, undesirably.

The tan δ is further required to have a maximum value at from 140° C. or more to less than 200° C. (hereinafter, the maximum value in this temperature range is referred to as a maximum value 2).

Taking account of the fact that no remarkable change is shown in general in the region where the loss elastic modulus G″ is more than 140° C., the fact that the tan δ has the maximum value 2 in this temperature range shows that the storage elastic modulus G′ having come to decrease with a rise in temperature has become gentle in the rate of its decrease, in the vicinity of the temperature at which the storage elastic modulus G′ indicates the maximum value. That is to say, this corresponds to the afore-said “the temperature dependence of G′ is made smaller than conventional one in the vicinity of the temperature at which the toner comes into a molten state”.

Where the maximum value 2 does not appear in the above temperature range, it follows that the G′ continues to decrease monotonously with a rise in temperature, so that the image gloss can not be kept in a preferable range when transfer materials of different types are used under the same fixing conditions.

Incidentally, the G″(140° C.) and tans in the present invention are those determined by the following method.

As a measuring instrument, ARES (manufactured by Rheometric Scientific F.E. Ltd.) is used. The storage elastic modulus G′, loss elastic modulus G″ and tan δ in the temperature range of from 40 to 200° C. are measured under the following conditions.

Measuring jig: Circular parallel plates of 8 mm in diameter are used. A shallow cup corresponding to the circular parallel plates is used on the side of an actuator. The distance between the bottom surface of the shallow cup and the circular parallel plates is about 2 mm.

Measuring sample: Used after the toner is so pressure-molded as to become a disklike sample of about 8 mm in diameter and about 2 mm in height.

Measurement frequency: 6.28 radian/second.

Setting of measurement strain: The initial value is set at 0.1%, and thereafter the measurement is made in an automatic measuring mode.

Extension correction of sample: Adjusted in the automatic measuring mode.

Measurement temperature: Heated at a rate of 2° C. per minute from 40° C. to 200° C.

The value of loss elastic modulus G″ at 140° C. which is found when the loss elastic modulus G″ is measured in the temperature range of from 40 to 200° C. is represented by G″ (140° C.).

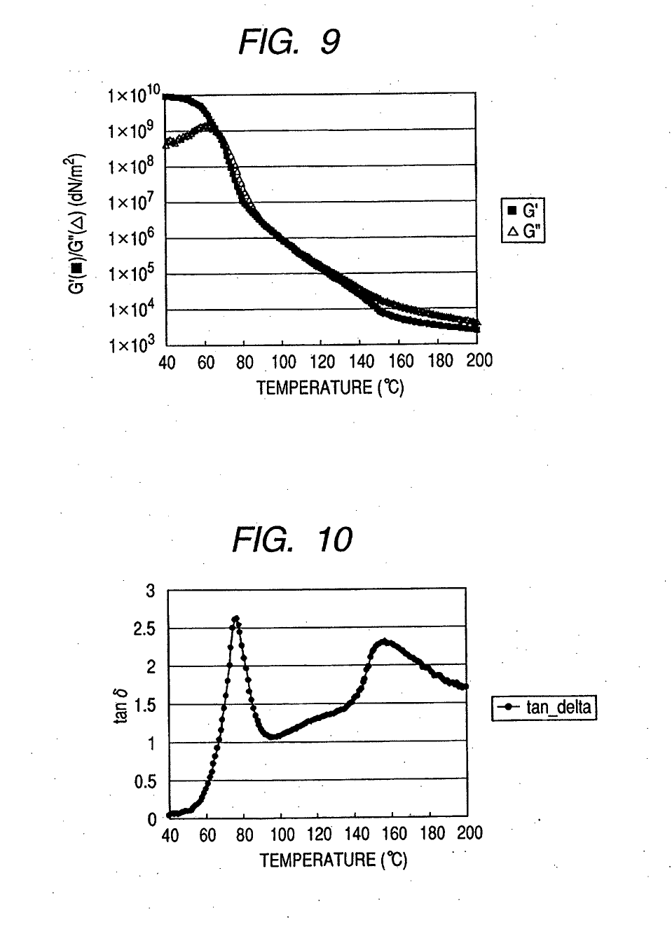

Examples of the storage elastic modulus G′ and loss elastic modulus G″ of the toner of the present invention are shown in FIG. 9.

An example of the loss tangent (tan δ) of the toner of the present invention is shown in FIG. 10.

In the present invention, it is also required that the binder resin is chiefly composed of a vinyl type copolymer. In the present invention, what is “chiefly composed” is to be contained in an amount of 50% by mass or more, and more preferably 80% by mass or more. Stated specifically, the binder resin may contain a copolymer formed of monomers selected from styrene and a styrene monomer; or a copolymer of a monomer selected from styrene and a styrene monomer and an acrylic ester monomer, or a copolymer of a monomer selected from styrene and a styrene monomer and a methacrylic ester monomer. As specific monomers, polymerizable monomers exemplified later may be used as polymerizable monomers usable in suspension polymerization.

The use of such a compound enables image qualities such as fine-line reproducibility, density stability and so forth of images to be maintained in a preferable state even when transfer materials of different types are used. The full reason therefor is unclear, and is presumed to be that the physical properties such as chargeability, environmental stability and brittleness the vinyl type copolymer has act synthetically to maintain at an equal level the transfer performance to transfer materials even when they are of different types.

Preferred embodiments of the toner of the present invention are described below.

In the present invention, the toner may preferably have an average circularity of 0.960 or more and 0.995 or less. The average circularity is considered to function as an index indicating the thermal conductivity to toner images at the time of fixing operation. That is, there are less gaps between toner particles in unfixed images as the average circularity of the toner comes closer to 1.000. On the other hand, where toner particles stand distorted, the gaps between toner particles in unfixed images are irregular to tend to cause faulty fixing because of a non-uniform way of heat conduction to the toner particles, stated specifically, to tend to cause come-off of toner images when the surfaces of fixed images are rubbed.

As to the influence such toner particles may have on the fixed images, it comes more remarkably when a film fixing assembly is used in which a heat source is brought into contact with toner images via a film. This is considered to be caused by the fact that the film fixing assembly is smaller in heat capacity of heating members than a heat roll fixing assembly.

The average circularity referred to in the present invention is used as a simple method for expressing the shape of particles quantitatively. In the present invention, the shape of particles is measured with a flow type particle image analyzer FPIA-1000, manufactured by Sysmex Corporation, and on a group of particles having a circle-equivalent diameter of 3 μm or more. The circularity (ai) of each particle is individually determined according to the following expression (1). As also further shown in the following expression (2), the value obtained when the sum total of circularities of all particles measured is divided by the number (m) of all particles is defined to be the average circularity (a).

$$\begin{matrix}Circularity ( ai ) = \frac{\begin{matrix}Circumferential length \\ of a circle with \\ the same projected \\ area as particle image\end{matrix}}{\begin{matrix}Circumferential length of \\ particle projected image\end{matrix}} . & Expression ( 1 ) \\ Average circularity ( a ) = {\sum }_{i = 1}^{m} ( ai / m ) & Expression ( 2 )\end{matrix}$$

Incidentally, the measuring device “FPIA-1000” used in the present invention employs a calculation method in which, in calculating the circularity of each particle and thereafter calculating the average circularity, particles are divided into classes in which the circularities of 0.40 to 1.00 are divided into 61 ranges in accordance with the circularities obtained, and the average circularity is calculated using the center values and frequencies of divided points. However, between the value of the average circularity calculated by this calculation method and the value of the average circularity calculated by the above calculation equation which uses the circularity of each particle directly, there is only a very small accidental error, which is at a level that is substantially negligible. Accordingly, in the present invention, such a calculation method in which the concept of the calculation equation which uses the above circularity of each particle directly is utilized and is partly modified may be used, for the reasons of handling data, e.g., making the calculation time short and making the operational equation for calculation simple.

As a specific measuring method, it is as described below. In 10 ml of water in which about 0.1 mg of a surface-active agent (alkylbenzenesulfonate) has been dissolved, 5 mg of the toner is dispersed to prepare a dispersion. Then the dispersion is exposed to ultrasonic waves (20 kHz, 50 W) for 5 minutes and the dispersion is made to have a concentration of 5,000 to 20,000 particles/μl, where the measurement is made using the above analyzer to determine the average circularity of the group of particles having a circle-equivalent diameter of 3 μm or more.

The average circularity referred to in the present invention is an index showing the degree of surface unevenness of toner particles. It is indicated as 1.000 when the particles are perfectly spherical. The more complicate the surface shape of toner particles is, the smaller the value of circularity is.

In this measurement, the reason why the circularity is measured only on the group of particles having a circle-equivalent diameter of 3 μm or more is that a group of particles of external additives that is present independently from toner particles are included in a large number in a group of particles having a circle-equivalent diameter of less than 3 μm. Hence, if particles to be measured are expanded to those having a circle-equivalent diameter of less than 3 μm, such particles may affect the measurement to make it difficult to accurately estimate the circularity on the group of toner particles.

In the present invention, the toner has a release agent (wax). The release agent may preferably be in a content of 2 parts by mass or more and 20 parts by mass or less based on 100 parts by mass of the binder resin. Inasmuch as the toner has the release agent, not only the image gloss on transfer materials of different types is maintained in a preferable state, but also the gloss can be controlled in a preferable state. Also, the toner can also effectively be kept from adhering to fixing members and the like.

If the release agent is in a content of less than 2 parts by mass based on 100 parts by mass of the binder resin, the effect to be brought out by the addition of the release agent may be insufficient, and the fixing members may be contaminated by the toner with their use over a long period of time, undesirably. If the release agent is in a content of more than 20 parts by mass based on 100 parts by mass of the binder resin, the toner may have a poor impact resistance, and the fixing members tend to be contaminated with their use over a long period of time, undesirably.

The release agent usable for the toner of the present invention may include petroleum waxes and derivatives thereof such as paraffin wax, microcrystalline wax and petrolatum; montan wax and derivatives thereof; hydrocarbon waxes obtained by Fischer-Tropsch synthesis, and derivatives thereof; polyethylene wax and derivatives thereof; and naturally occurring waxes such as carnauba wax and candelilla wax, and derivatives thereof. The derivatives include oxides, block copolymers with vinyl monomers, and graft modified products.

Preferable release agents usable in the present invention may include ester waxes belonging to compounds represented by the following Formulas (I) to (V). 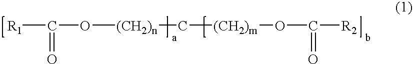
wherein a and b are each an integer of 0 to 4, provided that a+b is 4; R₁ and R₂ are each an organic group having 1 to 40 carbon atoms; and m and n are each an integer of 0 to 40, provided that m and n are not 0 at the same time. 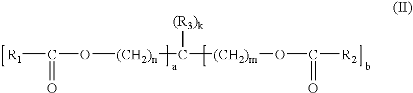
wherein a and b are each an integer of 0 to 3, provided that a+b is 1 to 3; R₁ and R₂ are each an organic group having 1 to 40 carbon atoms; R₃ is a hydrogen atom or an organic group having 1 or more carbon atoms; k is an integer of 1 to 3 and a+b+k=4; and m and n are each an integer of 0 to 40, provided that m and n are not 0 at the same time. 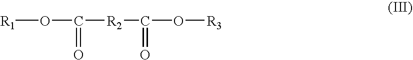
wherein R₁ and R₃ are each an organic group having 1 to 40 carbon atoms, and R₁ and R₃ may be the same or different; and R₂ represents an organic group having 1 to 40 carbon atoms. 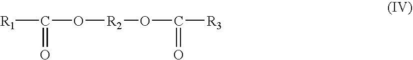
wherein R₁ and R₃ are each an organic group having 1 to 40 carbon atoms, and R₁ and R₃ may be the same or different; and R₂ represents an organic group having 1 to 40 carbon atoms. 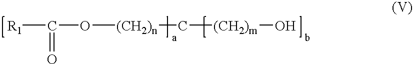
wherein a is an integer of 0 to 4 and b is an integer of 1 to 4, provided that a+b is 4; R₁ is an organic group having 1 to 40 carbon atoms; and m and n are each an integer of 0 to 40, provided that m and n are not 0 at the same time.

More preferable examples may include the following compounds.
CH₃(CH₂)₂₀COO(CH₂)₂₁CH₃ (1)
CH₃ (CH₂)₁₇COO(CH₂)₉OOC(CH₂)₁₇CH₃ (2)
CH₃ (CH₂)₁₇COO(CH₂)₁₈COO(CH₂)₁₇CH₃ (3)

A means for obtaining the toner according to the present invention is described below.

In order to obtain the toner having the preferable values on the G″(140° C.) and tan δ as referred to in the present invention, a method is available in which the molecular-weight distribution of the binder resin is controlled. In particular, a method is effective in which weight-average molecular weight (Mw) measured by gel permeation chromatography (GPC) is controlled. Stated specifically, a method is available in which reaction temperature in synthesizing the binder resin is controlled, or the type of an initiator and the amount of the initiator to be added are made to be preferable ones.

The binder resin may also be made to have a roughly cross-linked structure therein, to make gentle the temperature gradient of G′ in the vicinity of fixing temperature. This can also make its viscosity and elasticity preferable. Stated specifically, a method is available in which a compound having a molecular weight of about 200 to 300 and having a double bond on both terminals is introduced as a cross-linking component, or, in producing the toner by a polymerization process, a metal compound is added at the initial stage of polymerization reaction to make a very weak metal cross-linking reaction proceed in monomer droplets.

The toner according to the present invention may be produced by a pulverization process. However, the toner particles obtained by such pulverization commonly have an amorphous shape, and hence any mechanical or thermal treatment or any other treatment must be made in order to attain the physical properties that the average circularity be 0.960 or more, which are preferable requirements for the toner according to the present invention.

Accordingly, in the present invention, the toner particles may preferably be produced in water, and more preferably by polymerization. Methods for producing toner particles by polymerization may include direct polymerization, suspension polymerization, emulsion polymerization, emulsion association polymerization and seed polymerization. Of these, in view of the readiness to balance particle diameter and particle shape, it is particularly preferable to produce toner particles by suspension polymerization. In this suspension polymerization, a colorant and also optionally a polymerization initiator, a cross-linking agent, a charge control agent and other additives are uniformly dissolved or dispersed in a polymerizable monomer to form a monomer composition, and thereafter this monomer composition is dispersed in a continuous phase (e.g., an aqueous phase) containing a dispersion stabilizer, by means of a suitable stirrer to carry out polymerization reaction to obtain toner particles having the desired particle diameters. In the case when the toner particles are produced by this suspension polymerization, the individual toner particles stand uniform in substantially a spherical shape, and hence the toner which satisfies the requirements that the average circularity be 0.960 or more can be obtained with ease. Moreover, such a toner obtained by suspension polymerization can also have a relatively uniform charge quantity distribution, and hence has a high transfer performance.

A polymerizable monomer and a polymerization initiator may further again be added to the fine particles obtained by suspension polymerization to provide surface layers to obtain toner particles having a core/shell structure.

In the case when the toner according to the present invention is produced by polymerization, the polymerizable monomer constituting the monomer composition may include the following.

The polymerizable monomer may include styrene; styrene monomers such as o-methylstyrene, m-methylstyrene, p-methylstyrene, p-methoxystyrene and p-ethylstyrene; acrylic esters such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate and phenyl acrylate; methacrylic esters such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; and other monomers such as acrylonitrile, methacrylonitrile and acrylamides. Any of these monomers may be used alone or in the form of a mixture.

In the production of the polymerization toner according to the present invention, the polymerization may be carried out by adding a resin to the monomer composition. For example, a monomer component containing a hydrophilic functional group such as an amino group, a carboxylic group, a hydroxyl group, a sulfonic acid group, a glycidyl group or a nitrile group which can not be used because it is water-soluble as a monomer and hence dissolves in an aqueous suspension to cause emulsion polymerization should be introduced into toner particles, it may be used in the form of a copolymer such as a random copolymer, a block copolymer or a graft copolymer, of any of these with a vinyl compound such as styrene or ethylene, in the form of a polycondensation product such as polyester or polyamide, or in the form of a polyaddition polymer such as polyether or polyimine.

In the case when the resin containing such a polar functional group is used, one having a number-average molecular weight of 5,000 or more may preferably be used. If the resin containing a polar functional group has a number-average molecular weight of less than 5,000, especially 4,000 or less, since the resin tends to concentrate in the vicinity of the surfaces of toner particles, it tends to adversely affect developing performance and anti-blocking properties, undesirably. Also, as such a polar resin, a polyester type resin is particularly preferred.

For the purpose of improving dispersibility of materials, fixing performance or image characteristics, the following resin may also be added to the monomer composition. Such a resin may include, e.g., homopolymers of styrene and derivatives thereof, such as polystyrene and polyvinyl toluene; styrene copolymers such as a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-dimethylaminoethyl acrylate copolymer, a styrene-methyl methacrylate copolymer, a styrene-ethyl methacrylate copolymer, a styrene-butyl methacrylate copolymer, a styrene-dimethylaminoethyl methacrylate copolymer, a styrene-methyl vinyl ether copolymer, a styrene-ethyl vinyl ether copolymer, a styrene-methyl vinyl ketone copolymer, a styrene-butadiene copolymer, a styrene-isoprene copolymer, a styrene-maleic acid copolymer and a styrene-maleate copolymer; and polymethyl methacrylate, polybutyl methacrylate, polyvinyl acetate, polyethylene, polypropylene, polyvinyl butyral, silicone resins, polyester resins, polyamide resins, epoxy resins, polyacrylic acid resins, rosins, modified rosins, terpene resins, phenolic resins, aliphatic or alicyclic hydrocarbon resins, and aromatic petroleum resins; any of which may be used alone or in the form of a mixture.

Any of these resins may preferably be added in an amount of 1 part by mass or more and 20 parts by mass or less based on 100 parts by mass of the polymerizable monomer. Its addition in an amount of less than 1 part by mass may be low effective. Its addition in an amount of more than 20 part by mass makes it difficult to design various physical properties of the polymerization toner.

In addition, a polymer which has molecular weight distribution different from the molecular weight distribution of the toner obtained by polymerizing the polymerizable monomer may be dissolved in the monomer composition to polymerize the polymerizable monomer. This enables production of a toner having broad molecular weight distribution and high anti-offset properties.

Incidentally, in either case of the polymerization process and the pulverization process, the binder resin may preferably have a glass transition temperature (Tg) of 40° C. or more and 70° C. or less, more preferably 45° C. or more and 65° C. or less and still more preferably 55° C. or more and 65° C. or less. This binder resin may be used alone or by appropriate mixture with a monomer whose theoretical glass transition temperature (Tg) as described commonly in a publication POLYMER HANDBOOK, 2nd Edition, pp. 139-192 (John Wiley & Sons, Inc.) ranges 40° C. or more and 70° C. or less. If the theoretical glass transition temperature is less than 40° C., problems tend to arise in respect of storage stability and running stability of the toner. If it is more than 70° C., the toner may have a high fixing temperature. Especially in the case of color toners for forming full-color images, the color mixing performance at the time of the fixing of toners of respective colors may lower, resulting in a poor color reproducibility, undesirably.

The Tg of the toner is determined in the following way.

The Tg is determined from a DSC curve formed when a sample (toner) is first heated and then cooled and thereafter it is second-time heated, where the temperature at the point at which the middle line between the base line before the appearance of an endothermic peak and the base line after the appearance of the endothermic peak intersects the rising curve is regarded as Tg.

The toner of the present invention contains a colorant in order to afford coloring power. As organic pigments or organic dyes preferably used in the present invention, they may include the following.

Organic pigments or organic dyes usable as cyan colorants may include copper phthalocyanine compounds and derivatives thereof, anthraquinone compounds, basic dye lake compounds and so forth. Stated specifically, they may include C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62 and C.I. Pigment Blue 66.

As organic pigments or organic dyes usable as magenta colorants, condensation azo compounds, diketopyrrolopyrrole compounds, anthraquinone compounds, quinacridone compounds, basic-dye lake compounds, naphthol compounds, benzimidazolone compounds, thioindigo compounds and perylene compounds are used. Stated specifically, they may include C.I. Pigment Red 2, C.I. Pigment Red 3, C.I. Pigment Red 5, C.I. Pigment Red 6, C.I. Pigment Red 7, C.I. Pigment Red 19, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment. Red 122, C.I. Pigment Red 144, C.I. Pigment Red 146, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221 and C.I. Pigment Red 254.

Organic pigments or organic dyes usable as yellow colorants may include condensation azo compounds, isoindolinone compounds, anthraquinone compounds, azo metal complexes, methine compounds and allylamide compounds. Stated specifically, they may include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 191 and C.I. Pigment Yellow 194.

As black colorants, carbon black and colorants toned in black by the use of yellow, magenta and cyan colorants shown above may be used.

Any of these colorants may be used alone, in the form of a mixture, or further in the state of a solid solution. The colorants used in the toner of the present invention are selected taking account of hue angle, chroma, brightness, light-fastness, transparency on OHP films and dispersibility in toner particles.

The colorant may be used in its addition in an amount of 1 part by mass or more and 20 parts by mass or less based on 100 parts by mass of the binder resin.

In the case when the toner is obtained by polymerization, attention must be paid to polymerization inhibitory action or aqueous-phase transfer properties inherent in the colorants. The colorant may preferably be beforehand subjected to surface modification, e.g., hydrophobic treatment with a material free from polymerization inhibition. In particular, most dye type colorants and carbon black have the polymerization inhibitory action and hence care must be taken when used. A preferable method for the surface treatment of the dye type colorants may include a method in which the polymerizable monomer is beforehand polymerized in the presence of any of these dyes. The resultant colored polymer may be added to the monomer composition.

With regard to the carbon black, besides the same treatment as that on the dye type colorants, it may be treated with a material capable of reacting with surface functional groups of the carbon black, as exemplified by polyorganosiloxane.

In the case when color toners are produced, the colorants may preferably be selected from disazo type yellow pigments, quinacridone type magenta pigments and phthalocyanine type cyan pigments, and used.

In the case when the polymerization process is used in the present invention, as the polymerization initiator used in the production of the toner, a polymerization initiator having a half-life of 0.5 hours or more and 30 hours or less at the time of polymerization reaction may be used. The polymerization reaction may also be carried out in its addition in an amount of 0.5 part by mass or more and 20 parts by mass or less based on 100 parts by mass of the polymerizable monomer. This enables production of a polymer having a maximum in the region of molecular weight of 10,000 or more and 100,000 or less, so that the toner can be provided with desirable strength and suitable melt characteristics.

The polymerization initiator may include azo type or diazo type polymerization initiators such as 2,2′-azobis-2-methylbutyronitrile, 2,2′-azobis-(2,4-dimethylvaleronitrile), 2,2′-azobisisobutyronitrile, 1,1′-azobis-(cyclohexane-1-carbonitrile) and 2,2′-azobis-4-methoxy-2,4-dimethylvaleronitrile; and peroxide type polymerization initiators such as benzoyl peroxide, t-butyl peroxy-2-ethylhexanoate, t-butyl peroxypivarate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

In the case when the polymerization process is used in the present invention, a cross-linking agent may also be added to the polymerizable monomer composition. It may preferably be used in an amount of 0.001% by mass or more and 15% by mass or less based on the weight of the polymerizable monomer.

As the cross-linking agent, compounds having at least two polymerizable double bonds may be used. It may include, e.g., aromatic divinyl compounds such as divinyl benzene and divinyl naphthalene; carboxylic esters having two double bonds, such as ethylene glycol diacrylate, ethylene glycol dimethacrylate and 1,3-butanediol dimethacrylate; divinyl compounds such as divinyl aniline, divinyl ether, divinyl sulfide and divinyl sulfone; and compounds having at least three vinyl groups; any of which may be used alone or in the form of a mixture.

In the case when the polymerization process is used in the present invention, the above monomer composition (toner composition), i.e., a monomer system prepared commonly by appropriately adding to the polymerizable monomer the components necessary as toner particles, such as the colorant, the release agent, a plasticizer, a charge control agent and the cross-linking agent, and other additives as exemplified by an organic solvent, a high polymer and a dispersing agent which are added in order to lower the viscosity of the polymer formed by the polymerization reaction, and dissolving or dispersing these uniformly by means of a dispersion machine such as a homogenizer, a ball mill, a colloid mill or an ultrasonic dispersion machine, is suspended in an aqueous medium containing a dispersion stabilizer. Here, a high-speed dispersion machine such as a high-speed stirrer or an ultrasonic dispersion machine may be used to make the toner particles have the desired particle size at a stretch. This can more make the resultant toner particles have a sharp particle size distribution. As the time at which the polymerization initiator is added, it may be added simultaneously when other additives are added to the polymerizable monomer, or may be added immediately before the monomer composition (monomer system) is suspended in the aqueous medium. Also, a polymerization initiator having been dissolved in the polymerizable monomer or in a solvent may be added immediately after granulation and before the polymerization reaction is initiated.

After the granulation, agitation may be carried out using a usual agitator in such an extent that the state of particles is maintained and also the particles can be prevented from floating and settling.

In the case when the polymerization toner according to the image forming method of the present invention is produced, any known surface-active agent or organic or inorganic dispersant may be used as a dispersion stabilizer. In particular, the inorganic dispersant may hardly cause any harmful ultrafine powder and they attain dispersion stability on account of its steric hindrance. Hence, even when reaction temperature is changed, it may hardly loose the stability, can be washed with ease and may hardly adversely affect toners, and hence it may preferably be used. As examples of such an inorganic dispersant, it may include phosphoric acid polyvalent metal salts such as calcium phosphate, magnesium phosphate, aluminum phosphate and zinc phosphate; carbonates such as calcium carbonate and magnesium carbonate; inorganic salts such as calcium metasilicate, calcium sulfate and barium sulfate; and inorganic oxides such as calcium hydroxide, magnesium hydroxide, aluminum hydroxide, silica, bentonite and alumina.

Any of these inorganic dispersants may preferably be used in an amount of 0.2 part by mass or more and 20 parts by mass or less based on 100 parts by mass of the polymerizable monomer. In order to make the toner into finer particles, the inorganic dispersant may be used in combination with a surface-active agent used in an amount of from 0.001 part by mass or more and 0.1 part by mass or less based on 100 parts by mass of the polymerizable monomer.

Such a surface-active agent may include, e.g., sodium dodecylbenzenesulfate, sodium tetradecyl sulfate, sodium pentadecyl sulfate, sodium octyl sulfate, sodium oleate, sodium laurate, sodium stearate and potassium stearate.

When these inorganic dispersants are used, they may be used as they are. In order to obtain finer particles, particles of the inorganic dispersant may be formed in the aqueous medium. For example, in the case of calcium phosphate, an aqueous sodium phosphate solution and an aqueous calcium chloride solution may be mixed under high-speed stirring, whereby water-insoluble calcium phosphate can be formed and more uniform and finer dispersion can be effected. Here, water-soluble sodium chloride is simultaneously formed as a by-product. However, the presence of such a water-soluble salt in the aqueous medium keeps the polymerizable monomer from dissolving in water to make any ultrafine toner particles not easily formed by emulsion polymerization, and hence this is more favorable. Since its presence may be an obstacle when residual polymerizable monomers are removed at the termination of polymerization reaction, it is better to exchange the aqueous medium or desalt it with an ion-exchange resin. The inorganic dispersant can substantially completely be removed by dissolving it with an acid or an alkali after the polymerization is completed.

In the step of polymerization, the polymerization may be carried out at a polymerization temperature set at 40° C. or above, and commonly at a temperature of 50° C. or higher and 90° C. or lower. When polymerization is carried out within this temperature range, the release agent or wax to be enclosed inside the toner particles comes deposited by phase separation to come enclosed more perfectly. In order to consume residual polymerizable monomers, the reaction temperature may be raised to 90° C. or higher and 100° C. or lower if it is done at the termination of polymerization reaction.

The polymerization toner particles are obtained by, after the polymerization is completed, carrying out filtering, washing and drying by known methods, where inorganic fine particles may thereafter be mixed to make them adhere to the toner particle surfaces. The step of classification may also be added to the production process to remove any coarse powder and fine powder. This is also a desirable embodiment of the present invention.

In the case when the toner according to the present invention is produced by pulverization, any known method may be used. For example, the components necessary as toner particles, such as the binder resin, the colorant, the release agent, a charge control agent and optionally the colorant, and other additives are thoroughly mixed by mean of a mixer such as Henschel mixer or a ball mill, thereafter the mixture obtained is melt-kneaded by means of a heat kneading machine such as a heat roll, a kneader or an extruder to make the resin and so on melt one another, into which other toner materials are dispersed or dissolved. The resultant kneaded product is cooled to solidify, followed by pulverization, thereafter classification and optionally surface treatment to obtain toner particles. Either of the classification and the surface treatment may be first in order. In the step of classification, a multi-division classifier may preferably be used in view of production efficiency.

The pulverization step may be carried out by any method making use of a known pulverizer such as a mechanical impact type pulverizer or a jet type pulverizer.

The toner according to the present invention may still also be produced by the method disclosed in Japanese Patent Application Laid-open No. S56-013945, in which a molten mixture is atomized in air by means of a disk or a multiple fluid nozzle to obtain spherical toner particles; a dispersion polymerization method in which toner particles are directly produced using an aqueous organic solvent capable of dissolving polymerizable monomers and not capable of dissolving the resultant polymer; an emulsion polymerization method as typified by a soap-free polymerization method in which toner particles are produced by direct polymerization in the presence of a water-soluble polar polymerization initiator; and so forth.

The toner of the present invention may be mixed with a charge control agent in order to stabilize charge characteristics. As the charge control agent, any known agent may be used. In particular, a charge control agent is preferred which affords a high charging speed and can stably maintain a constant charge quantity. Further, in the case when the toner particles are directly produced by polymerization, particularly preferred are charge control agents having a low polymerization inhibitory action and substantially free of any solubilizate to the aqueous dispersion medium. As specific compounds, a negative charge control agent may include metal compounds of aromatic carboxylic acids such as salicylic acid, alkylsalicylic acids, dialkylsalicylic acids, naphthoic acid and dicarboxylic acids; metal salts or metal complexes of azo dyes or azo pigments; polymer type compounds having a sulfonic acid or carboxylic acid group in the side chain; as well as boron compounds, urea compounds, silicon compounds, and carixarene. A positive charge control agent may include quaternary ammonium salts, polymer type compounds having such a quaternary ammonium salt in the side chain, guanidine compounds, Nigrosine compounds and imidazole compounds.

The charge control agent may preferably be used in an amount of 0.5 part by mass or more and 10 parts by mass or less based on 100 parts by mass of the polymerizable monomer or based on 100 parts by mass of the binder resin. However, the addition of the charge control agent is not essential in the present invention. The triboelectric charging between the toner and the toner layer thickness control member and developer carrying member may actively be utilized, and this makes it not always necessary for the toner to contain the charge control agent.

The toner of the present invention may preferably have a weight-average particle diameter (D4) of 3.0 μm or more and 10.0 μm or less, and more preferably from 4.0 μm or more and 8.0 μm or less, in order to develop minuter latent image dots. In a toner having a weight-average particle diameter of less than 3.0 μm, the transfer residual toner may remain on the photosensitive member in a large quantity because of a lowering of transfer efficiency, resulting in a lowering of image quality. Also, in the case of a toner having a weight-average particle diameter of more than 10.0 μm, spots around line images tend to occur in character and line images, making it difficult to attain a high resolution.

The weight-average particle diameter and number-average particle diameter of the toner of the present invention may be measured with Coulter Counter Model TA-II or Coulter Multisizer (manufactured by Coulter Electronics, Inc.). Stated specifically, they may be measured in the following way: Coulter Multisizer (manufactured by Coulter Electronics, Inc.) is used. An interface (manufactured by Nikkaki Bios Co., Ltd.) that outputs number distribution and volume distribution and a personal computer PC9801 (manufactured by NEC.) are connected. As an electrolytic solution, an aqueous 1% NaCl solution is prepared using first-grade sodium chloride. For example, ISOTON R-II (available from Coulter Scientific Japan Co.) may be used. Procedure of measurement is as follows:

From 100 to 150 ml of the above aqueous electrolytic solution is added, and from 2 to 20 mg of a sample to be measured is further added. The electrolytic solution in which the sample has been suspended is subjected to dispersion treatment for about 1 minute to about 3 minutes in an ultrasonic dispersion machine. The volume distribution and number distribution are calculated by measuring the volume and number of toner particles of 2 μm or more in particle diameter by means of the above Coulter Multisizer, using an aperture of 100 μm as its aperture. From the values obtained, the weight-average particle diameter (D4) and the number-average particle diameter (D1) are determined.

In the present invention, any commonly known fine powder of various types may optionally be added as an external additive to toner particle (toner base particle) surfaces.

As the external additive which may be used in the present invention, any known inorganic fine powder or resin particles are used. In order to improve charge stability, developing performance, fluidity and storage stability of the toner, it may preferably be selected from inorganic fine powders of silica, alumina and titania or double oxides thereof.

For the purpose of making hydrophobic, controlling chargeability and so forth, it is preferable for the external additive used in the present invention to have been treated with a treating agent of various types such as an unmodified silicone varnish, a modified silicone varnish of various types, an unmodified silicone oil, a modified silicone oil of various types, a silane coupling agent, a silane coupling agent having a functional group, other organic silicon compound, and an organic titanium compound.

As a method for the external addition, a conventionally known method may be used which makes use of Henschel mixer or the like.

The image forming method and the image forming apparatus and process cartridge which practice the method are described below with reference to the drawings.

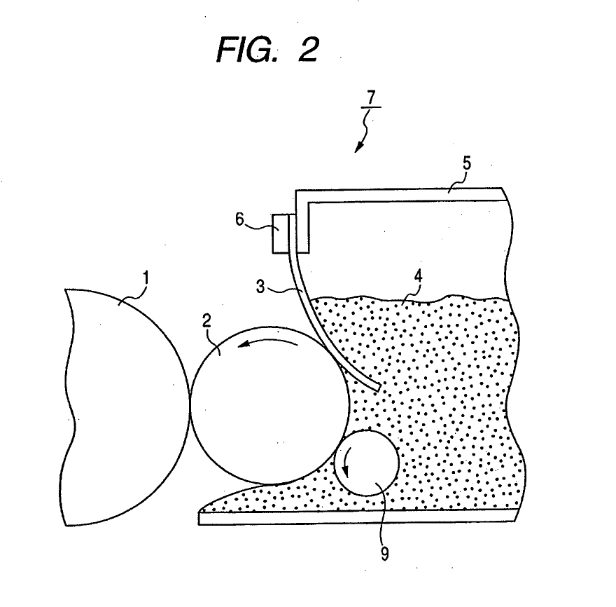

A developing apparatus 7 is described first with reference to FIG. 2.

In FIG. 2, reference numeral 5 denotes a toner container which holds therein a non-magnetic toner 4 as a one-component developer. A developing roller 2 as a toner bearing member disposed facing an electrostatic latent image bearing member photosensitive drum 1 (photosensitive member) is rotatably disposed at an opening extending in the lengthwise direction inside the toner container 5. Also, the developing roller 2 is laterally provided in such a way that it is thrust into the toner container 5 by the right half of its peripheral surface as viewed in FIG. 2 and is exposed to the outside of the toner container 5 by the left half of its peripheral surface.

A control blade 3 as the toner layer control member is so provided as to be supported by a holder sheet metal 6 at the upper position of the developing roller 2. The control blade 3 is, in the vicinity of its free end side, kept in touch with the peripheral surface of the developing roller 2 in the state of face-to-face touch. The direction in which the control blade 3 is kept in touch with the developing roller 2 is what is called the counter (opposite) direction where the former's end side is positioned on the upstream side in the rotational direction of the developing roller 2 with respect to the touch portion. Also, a coating roller 9 for feeding the toner is kept in contact with the developing roller 2.

As the toner bearing member, an elastic roller is used, where a developing system may be used in which the elastic roller is coated on its surface with the toner to form a toner layer and this toner layer is brought into touch with the photosensitive member surface. In general, in the developing system in which the toner bearing member and the photosensitive member come into contact with each other, the toner particles tend to break or deform. However, the use of the toner of the present invention is preferable because such changes can effectively be prevented.

In this case, the electric field acting between the photosensitive member and the elastic roller facing the photosensitive member surface through the toner is utilized to perform development. Hence, it is necessary for the elastic roller surface or the vicinity of the surface to have a potential so that an electric field is formed at a narrow gap between the photosensitive member surface and the elastic roller surface. Accordingly, a method may also be used in which the elastic rubber of the elastic roller is controlled to have a resistance in the medium-resistance region to keep the electric field while preventing its conduction to the photosensitive member surface, or a thin-layer insulating layer is provided on the surface layer of the elastic roller (conductive layer). It is also possible to make up a conductive resin sleeve comprising the conductive roller, which is covered thereon with an insulating material on its side facing the photosensitive member surface, or an insulating sleeve provided with a conductive layer on its side not facing the photosensitive member surface. It is still also possible to make up a rigid-material roller used as the toner bearing member and a flexible member such as a belt used as the photosensitive member. The roller as the toner bearing member may preferably have a volume resistivity in the range of from 10² Ωcm or more and 10⁹ Ωcm or less.

As the surface profile of the toner bearing member 2, its surface roughness Ra (μm) may be so set as to be 0.2 or more and 3.0 or less. This enables achievement of both high image quality and high running performance. The surface roughness Ra correlates with toner transportability and toner chargeability. If the toner bearing member has a surface roughness Ra of more than 3.0, not only the toner layer on the toner bearing member can be made thin with difficulty but also the performance to provide the toner with triboelectric charges may lower, and hence the image quality can not be expected to be improved. Setting the surface roughness Ra (μm) to be 3.0 or less enables control of the toner transportability the toner bearing member surface has, and makes thin the toner layer on the toner bearing member, and also makes large the number of times the toner bearing member comes into contact with the toner. Hence, the performance to provide the toner with triboelectric charges can also be improved to cooperatively bring an improvement in image quality. On the other hand, if the toner bearing member has a surface roughness Ra of less than 0.2, it is difficult to control the toner coat level.

In the present invention, the surface roughness Ra of the toner bearing member corresponds to the centerline average roughness measured with a surface roughness measuring instrument (SURFCORBER SE-30H, manufactured by Kosaka Laboratory Ltd.) according to JIS surface roughness “JIS B 0601 (2001)”. Stated specifically, a portion of 2.5 mm is drawn out of the roughness curve, setting a measurement length a in the direction of its centerline. When the centerline of this drawn-out portion is represented by X axis, the direction of lengthwise magnification by Y axis, and the roughness curve by y=f(x), the value determined according to the following expression and indicated in micrometer (μm) is the surface roughness Ra. A cut-off value is set λ=0.8 mm.

$$Ra = ( 1 / a ) {\int }_{0}^{a} \vert f ( x ) \vert ⅆ x$$

In the present invention, the toner bearing member may be rotated in the same direction as, or the reverse direction to, the electrostatic latent image bearing member. In the case when the both are rotated in the same direction, the peripheral speed of the toner bearing member may preferably be set 1.05 to 3.0 times the peripheral speed of the electrostatic latent image bearing member.

If the peripheral speed of the toner bearing member is less than 1.05 times the peripheral speed of the electrostatic latent image bearing member, the agitation effect the toner on the electrostatic latent image bearing member undergoes may be insufficient, so that no good image quality may be expected. If on the other hand their peripheral speed ratio is more than 3.0, the deterioration of toner that is due to mechanical stress or the sticking of toner to the toner bearing member tends to occur and be accelerated, undesirably.

As the electrostatic latent image bearing member, preferably used is a photosensitive drum or photosensitive belt having a photoconductive insulating material layer formed of a-Se, CdS, ZnO₂, OPC (organic photoconductor) or a-Si (amorphous silicon). Also, the binder resin of an organic photosensitive layer of the OPC photosensitive member may include, but is not particularly limited to, polycarbonate resins, polyester resins and acrylic resins, which are particularly preferred because they promise superior transfer performance and can not easily cause the melt adhesion of toner and filming of external additives to the photosensitive member.

The image forming method is described below with reference to the accompanying drawings.

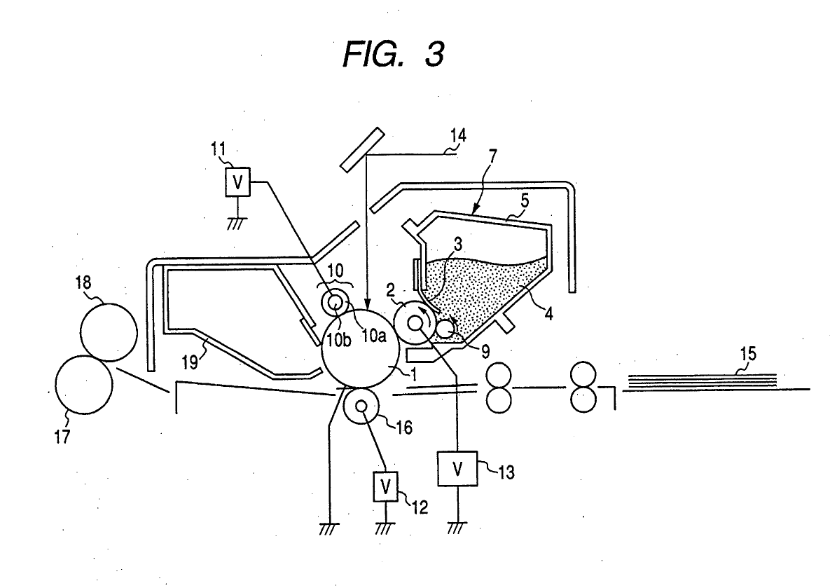

FIG. 3 schematically illustrates the construction of an example of an image forming apparatus having a process cartridge and a developing apparatus, which practices the image forming method of the present invention. In FIG. 3, reference numeral 10 denotes a charging roller as a primary charging member which directly charges an electrostatic latent image bearing member (photosensitive drum) 1 in contact with it; 11 to 13, bias power sources; 15, transfer materials such as sheets of paper; 16, a transfer member; 17, a fixing pressure roller; 18, a fixing heating roller; and 19, a cleaner. The same members as those shown in FIG. 2 are denoted by the same reference numerals.

To the charging roller 10, the bias power source 11 is connected so that the surface of the photosensitive drum 1 may uniformly be charged. The developing apparatus 7 holds a toner 4 in its toner container 5, and has a developing roller 2 which is a toner bearing member rotated in the direction of an arrow. It also has a control blade 3 which is a toner layer control member for controlling toner coat level and charging the toner, and a coating roller 9 which is rotated in the direction of an arrow in order to cause the toner 4 to adhere to the developing roller 2 and also provide the toner with triboelectric charges by its friction with the developing roller 2. To the developing roller 2, a development bias power source 13 is connected. A bias power source (not shown) is also connected to the coating roller 9, where a voltage is set on the negative side with respect to the development bias when a negatively chargeable toner is used and on the positive side with respect to the development bias when a positively chargeable toner is used.

A power source 12 for transfer bias with a polarity reverse to that of the photosensitive drum 1 is connected to the transfer member 16.

As the toner bearing member developing roller 2, what is called an elastic roller may preferably be used, which has an elastic layer at the surface. As materials for the elastic layer used in the elastic roller, those having a hardness of 30 degrees or more and 60 degrees or less (Asker-C/load 1 kg)) may preferably be used.

The toner coat level is controlled by the control blade 3. This control blade 3 is kept in touch with the developing roller 2 through the toner layer. Here, the pressure of contact between the control blade 3 and the developing roller 2 may preferably be in the range of 0.05 N/cm or more and 0.50 N/cm or less as linear pressure in the generatrix direction of the developing roller 2.

Incidentally, the linear pressure refers to the load applied to the control blade 3 per unit length thereof. For example, when a load of 1.2 N is applied to a blade 3 having a touch length of 1 m and this blade is brought into contact with the developing roller 2, the linear pressure is 1.2 N/m. If the linear pressure is less than 0.05 N/cm, it may be difficult not only to control the toner coat level but also to perform uniform triboelectric charging, tending to, e.g., cause fog seriously. If on the other hand the linear pressure is more than 0.50 N/cm, the toner may undergo an excess load to tend to cause the deformation of toner particles or the melt-adhesion of toner to the control blade 3 and developing roller 2, undesirably.

The free edge of the control blade 3 may have any shape. For example, it may be linear in its sectional shape, and besides may be in L-shape, bent in the vicinity of the edge, or may be in a shape made spherical in the vicinity of the edge, any of which may preferably be used.

As the toner layer control member, an elastic member made of a metal such as stainless steel, copper or phosphor bronze may be used as its substrate, and a resin may be provided by bonding or coating at its part coming into touch with the touch portion of the developing roller 2 (sleeve). Such a blade may preferably be used.

A DC electric field and/or an AC electric field may also be applied to the toner layer control member, whereby the uniform thin-layer coating performance and uniform charging performance can be more improved because of the loosening action acting on the toner, so that a sufficient image density can be achieved and images with a good quality can be formed.

In the apparatus shown in FIG. 3, the photosensitive drum 1 rotating in the direction of an arrow is uniformly electrostatically charged by a primary charging member. In this example, the primary charging member is a charging roller 10 constituted basically of a mandrel 10b at the center and a conductive elastic layer 10a that forms the periphery of the former. The charging roller 10 is kept in contact with some part of the surface of the electrostatic latent image bearing member photosensitive drum 1 at a pressing force and is rotated followingly as the photosensitive drum 1 is rotated.

As preferable process conditions when the charging roller 10 is used, the contact pressure of the charging roller 10 is 0.05 N/cm or more and 5 N/cm or less, and DC voltage alone or a bias formed by superimposing an AC voltage on a DC voltage is used as the applied voltage. Though not particularly limited, when the one formed by superimposing an AC voltage on a DC voltage is used, AC voltage is 0.5 to 5 kVpp, AC frequency is 50 Hz or more and 5 kHz or less, DC voltage is plus-minus 0.2 to plus-minus 1.5 kV. When the DC voltage is used, DC voltage is plus-minus 0.2 to plus-minus 5 kV. In the present invention, the applied voltage formed of DC voltage only may preferably be used.

As a charging means other than the charging roller 10, available are a method making use of a charging blade and a method making use of a conductive brush. These contact charging means have the effect of, e.g., making high voltage unnecessary and making ozone less occur, compared with non-contact, corona charging. The charging roller and charging blade as contact charging means may preferably be made of a conductive rubber, and a release coat may be provided on its surface. The release coat may be formed of a nylon resin, PVDF (polyvinylidene fluoride) or PVDC (polyvinylidene chloride), any of which may be used.

Subsequently to the step of charging the electrostatic latent image bearing member (photosensitive drum 1), an electrostatic latent image corresponding to information signals is formed on the photosensitive drum 1 by exposure 14 from a light-emitting device, and the electrostatic latent image is developed with the toner at the position coming into contact with the developing roller 2, to form a visible image. Further, a development system of forming a digital latent image on the photosensitive drum 1 may be used in combination. This enables development faithful to a dot latent image because the latent image is not disordered. The visible image is transferred to the transfer material 15 by means of the transfer member 16, which is then passed through between the fixing heating roller 18 and the fixing pressure roller 17, and is fixed to obtain a permanent image.

Meanwhile, transfer residual toner not transferred and having remained on the photosensitive drum 1 is collected by means of a cleaner 19 having a cleaning blade kept in contact with the surface of the photosensitive drum 1. Thus, the photosensitive drum 1 is cleaned.

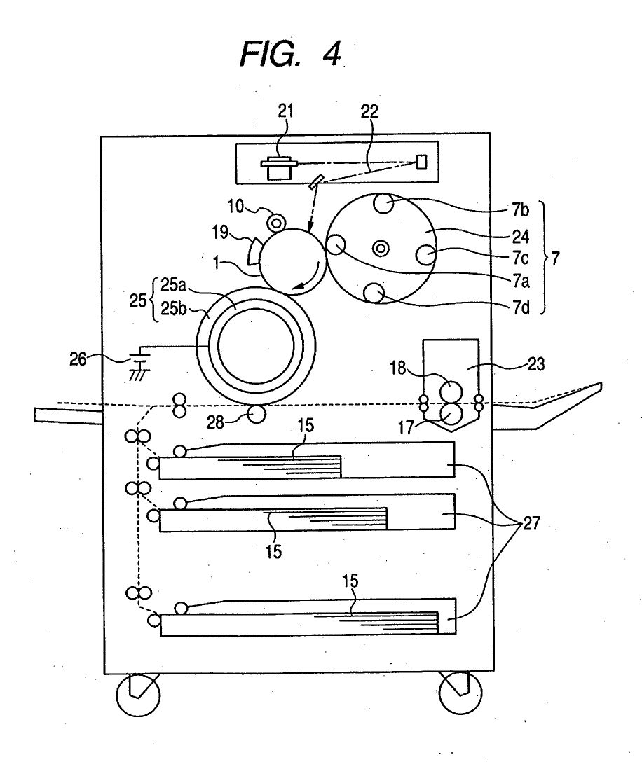

FIG. 4 schematically illustrates the construction of an example of an image forming apparatus in which a multiple toner image is one-time transferred to a transfer material by using an intermediate transfer member and to which the image forming method of the present invention is applicable.

In FIG. 4, reference numeral 7 denotes developing assemblies (reference numerals 7a to 7d denote developing assemblies for respective colors of black, yellow, magenta and cyan, respectively; 21, a light source assembly; 22, laser light; 23, a fixing assembly; 24, a developing unit having the developing assemblies 7a to 7d; 25, an intermediate transfer drum as an intermediate transfer member; 25a, a conductive support; 25b, an elastic layer; 26, a bias power source; 27, transfer material trays; and 28, a secondary transfer apparatus. The same members as those shown in FIGS. 2 and 3 are denoted by the same reference numerals.

A rotatable charging roller 10 as a charging member, to which a charging bias voltage is kept applied, is brought into contact with the surface of a photosensitive drum 1 as an electrostatic latent image bearing member while rotating the charging roller 10, to effect uniform primary charging of the photosensitive drum 1 surface. Then, a first electrostatic latent image is formed on the photosensitive drum 1 by its exposure to the laser light 22 emitted from the light source assembly 21 as an exposure means. The first electrostatic latent image thus formed is developed with a black toner held in the black developing apparatus 7a as a first developing apparatus, to form a black toner image; the developing apparatus 7a being provided in the rotatable developing unit 24. The black toner image formed on the photosensitive drum 1 is primarily electrostatically transferred onto the intermediate transfer drum 25 by the action of a transfer bias voltage applied to the conductive support 25a of the intermediate transfer drum 25.

Next, a second electrostatic latent image is formed on the surface of the photosensitive drum 1 in the same way as the above, and the developing unit 24 is rotated to develop the second electrostatic latent image with a yellow toner held in the yellow developing apparatus 7b as a second developing apparatus, to form a yellow toner image. The yellow toner image is primarily electrostatically transferred onto the intermediate transfer drum 25 on which the black toner image has primarily been transferred. Similarly, third and fourth electrostatic latent images are formed and, rotating the developing unit 24, they are sequentially developed with a magenta toner held in the magenta developing apparatus 7c as a third developing apparatus and a cyan toner held in the cyan developing apparatus 7d as a fourth developing apparatus, respectively, and the magenta toner image and cyan toner image formed are primarily transferred. Thus, the toner images of respective colors are primarily respectively transferred as a multiple toner image, onto the intermediate transfer drum 25.

The multiple toner image primarily transferred onto the intermediate transfer drum 25 is secondarily electrostatically one-time transferred onto a transfer material 15 by the action of a transfer bias voltage applied from a second transfer apparatus 28 positioned on the opposite side via the transfer material 15. The multiple toner image secondarily transferred onto the transfer material 15 is fixed by heat and pressure to the transfer material 15 by means of a fixing assembly 23 having a fixing pressure member 17 and a fixing heating member 18. Thus, a full-color image is formed on the transfer material 15. Transfer residual toner remaining on the surface of the photosensitive drum 1 after transfer is collected by a cleaner 19 having a cleaning blade coming in contact with the surface of the photosensitive drum 1, thus the photosensitive drum is cleaned.

For the primary transfer from the photosensitive drum 1 to the intermediate transfer drum 25, a transfer electric current is formed by applying a bias from a bias power source 26 to a conductive support 25a of the intermediate transfer drum 25 serving as a first transfer means, thus the toner images can be transferred.

The intermediate transfer drum 25 comprises the conductive support 25a, which is a rigid body, and an elastic layer 25b which covers its surface. As the conductive support 25a, it may be formed using a metal such as aluminum, iron, copper or stainless steel, or a conductive resin with conductive particles such as carbon or metal particles dispersed therein. As the shape of the intermediate transfer drum 25, it may be a cylinder, a cylinder through the center of which a shaft is passed, or a cylinder reinforced on its inside.

As a material for the elastic layer 25b, preferably usable are, but not particularly limited to, elastomer rubbers such as styrene-butadiene rubber, high styrene rubber, butadiene rubber, isoprene rubber, an ethylene-propylene copolymer, nitrile butadiene rubber (NBR), chloroprene rubber, butyl rubber, silicone rubbers, fluororubbers, nitrile rubber, urethane rubbers, acrylic rubbers, epichlorohydrin rubber and norbornane rubber. Resins such as polyolefin resins, silicone resins, fluorine resins and polycarbonate resins, and copolymers or mixtures of any of these may also be used.

On the surface of the elastic layer 25b, a surface layer may further be formed in which a highly lubricating and water-repellent lubricant powder has been dispersed in any desired binder.

As the lubricant, preferably usable are, but not particularly limited to, various types of fluororubbers, fluoroelastomers, carbon fluorides comprising fluorine-bonded graphite, fluorine compounds such as polytetrafluoroethylene (PTFE), polyvinylidene fluoride (PVDF), an ethylene-tetrafluoroethylene copolymer (ETFE) and a tetrafluoroethylene-perfluoroalkyl vinyl ether copolymers (PFA), silicone compounds such as silicone resins, silicone rubbers and silicone elastomers, as well as polyethylene (PE), polypropylene (PP), polystyrene (PS), acrylic resins, polyamide resins, phenol resins, and epoxy resins.

To the binder of the surface layer, a conducting agent may also appropriately be added in order to control its resistance. The conducting agent may include various types of conductive inorganic particles, and also carbon black, ionic conducting agents, conductive resins and conductive-particle-dispersed resins.

The multiple toner image on the intermediate transfer drum 25 is secondarily one-time transferred onto the transfer material 15 by means of the second transfer apparatus 28. Usable as the transfer apparatus 28 is a non-contact electrostatic transfer means making use of a corona charging assembly, or a contact electrostatic transfer means making use of a transfer roller or a transfer belt.

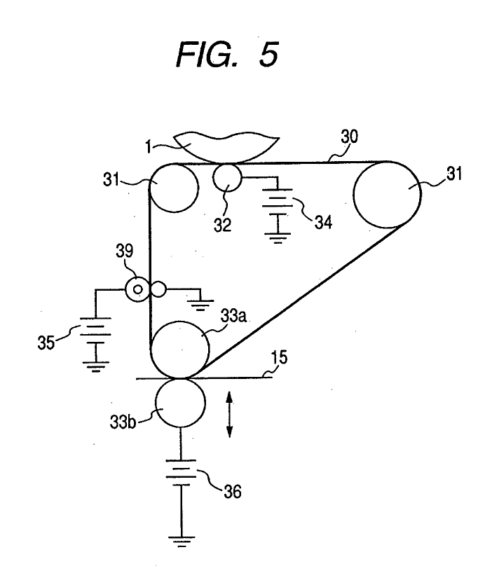

In place of the intermediate transfer drum 25 used as the intermediate transfer member in the image forming apparatus shown in FIG. 4, an intermediate transfer belt may be used to one-time transfer the multiple toner image to the recording medium. FIG. 5 partially schematically illustrates the construction of an image forming apparatus making use of such an intermediate transfer belt.

In FIG. 5, reference numeral 30 denotes an intermediate transfer belt; 31, rollers over which the intermediate transfer belt 30 is stretched; 32, a primary transfer roller; 33a, a secondary transfer opposing roller; 33b, a secondary transfer roller; 34 to 36, bias power sources; and 39, a cleaning-purpose charging member. The same members as those shown in FIGS. 2 to 4 are denoted by the same reference numerals.

In the construction shown in FIG. 5, in the course the toner images formed and held on an electrostatic latent image bearing member (photosensitive drum) 1 pass a nip between the photosensitive drum 1 and the intermediate transfer belt 30, they are primarily sequentially transferred to the peripheral surface of the intermediate transfer belt 30 by the aid of an electric field formed by a primary transfer bias applied to the intermediate transfer belt 30 through a primary transfer roller 32.

The primary transfer bias for the sequential superimposing transfer of the first- to fourth-color toner images from the photosensitive drum 1 to the intermediate transfer belt 30 has a polarity reverse to that of the toner and is applied from the bias power source 34.

In the step of primary transfer of the first- to fourth-color toner images from the photosensitive drum 1 to the intermediate transfer belt 30, the secondary transfer roller 33b and the cleaning-purpose charging member 39 may be separated from the intermediate transfer belt 30.

The secondary transfer roller 33b is axially supported in parallel to the secondary transfer opposing roller 33a and is so provided as to be separable from the bottom part of the intermediate transfer belt 30.

To transfer to a transfer material 15 a synthesized multiple color toner image transferred onto the intermediate transfer belt 30, the secondary transfer roller 33b is brought into contact with the intermediate transfer belt 30 and also the transfer material 15 is fed to the contact nip between the intermediate transfer belt 30 and the secondary transfer roller 33b at a given timing, where a secondary transfer bias is applied from the bias power source 36 to the secondary transfer roller 33b. By the aid of this secondary transfer bias, the multiple toner image is secondarily transferred from the intermediate transfer belt 30 to the transfer material 15.

After the image transfer to the transfer material 15 is completed, the cleaning-purpose charging member 39 is brought into contact with the intermediate transfer belt 30, and a bias having a polarity reverse to that of the photosensitive drum 1 is applied from the bias power source 35, so that electric charges having a polarity reverse to that of the photosensitive drum 1 are imparted to the toner (transfer residual toner) remaining on the intermediate transfer belt 30 without being transferred to the transfer material 15. Then, the transfer residual toner is transferred to the photosensitive drum 1 at the nip between the intermediate transfer belt 30 and the photosensitive drum 1 and in the vicinity thereof, thus the intermediate transfer belt 30 is cleaned.

The intermediate transfer belt 30 comprises a beltlike base layer and a surfacing layer provided on the base layer. The surfacing layer may be constituted of a plurality of layers.

In the base layer and the surfacing layer, rubber, elastomer or resin may be used. For example, as the rubber and the elastomer, usable are one or more materials selected from the group consisting of natural rubber, isoprene rubber, styrene-butadiene rubber, butadiene rubber, butyl rubber, ethylene-propylene rubber, an ethylene-propylene copolymer, chloroprene rubber, chlorosulfonated polyethylene, chlorinated polyethylene, acrylonitrile butadiene rubber, urethane rubbers, syndioctactic 1,2-polybutadiene, epichlorohydrin rubber, acrylic rubbers, silicone rubbers, fluororubbers, polysulfide rubbers, polynorbornane rubber, hydrogenated nitrile rubbers, and thermoplastic elastomers (e.g., polystyrene type, polyolefin type, polyvinyl chloride type, polyurethane type, polyamide type, polyester type and fluorine resin type elastomers), but not limited to these materials. As the resin, resins such as polyolefin resins, silicone resins, fluorine resins and polycarbonate resins may be used. Copolymers or mixtures of any of these resins may also be used.

As the base layer, any of the above rubbers, elastomers and resins formed into films may be used. A core material layer may also be used which has the form of woven fabric, nonwoven fabric, yarn or film on one side or both sides of which any of the above rubbers, elastomers and resins is coated, soaked or sprayed.

The material constituting the core material layer may include, e.g., natural fibers such as cotton, silk, hemp and wool; regenerated fibers such as chitin fiber, alginic acid fiber and regenerated cellulose fiber; semisynthetic fibers such as acetate fiber; synthetic fibers such as polyester fiber, nylon fiber, acrylic fiber, polyolefin fiber, polyvinyl alcohol fiber, polyvinyl chloride fiber, polyvinylidene chloride fiber, polyurethane fiber, polyalkylparaoxybenzoate fiber, polyacetal fiber, aramid fiber, polyfluoroethylene fiber and phenol fiber; inorganic fibers such as carbon fiber, glass fiber and boron fiber; and metal fibers such as iron fiber and copper fiber. One or more materials selected from the group consisting of these may be used. Of course, examples are by no means limited to the above materials.

A conducting agent may further be added to the base layer and surfacing layer in order to control the resistivity of the intermediate transfer belt 30. As the conducting agent, usable are, but not particularly limited to, e.g., carbon powder, metal powders such as aluminum or nickel powder, metal oxides such as titanium oxide, and conductive polymeric compounds such as quaternary-ammonium-salt-containing polymethyl methacrylate, polyvinyl aniline, polyvinyl pyrrole, polydiacetylene, polyethyleneimine, boron-containing polymeric compounds, and polypyrrole. One or more conducting agents selected from the group consisting of these may be used. However, examples are by no means limited to the above conducting agents.

A lubricant may also optionally be added in order to improve the lubricity of the intermediate transfer belt 30 surface to improve its transfer performance. As the lubricant, preferably usable are, but not particularly limited to, the same lubricant as mentioned the lubricant to be dispersed in the surface layer of the elastic layer.

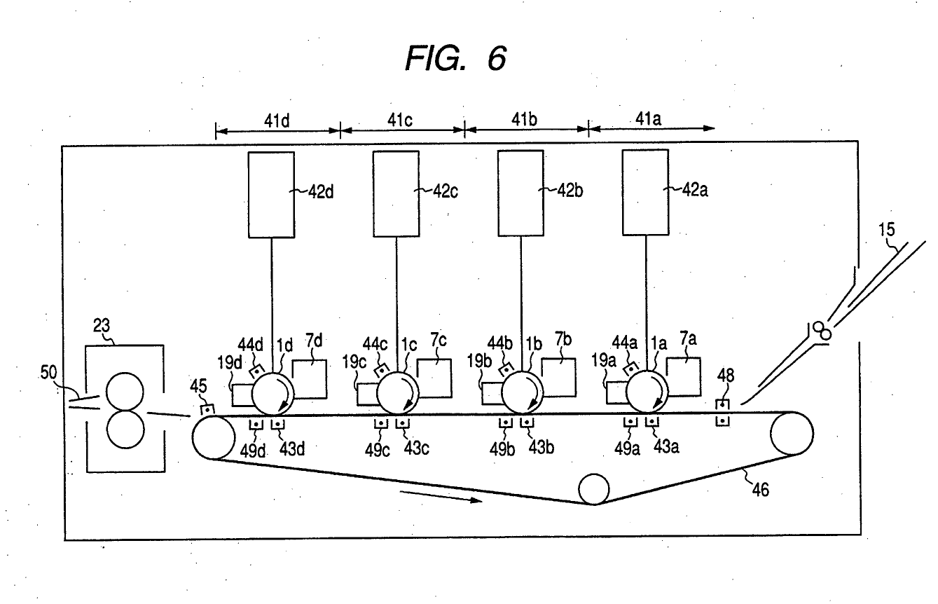

The construction of an image forming apparatus is described with reference to its schematic view FIG. 6, in which apparatus the toner images of different colors are respectively formed in a plurality of image forming sections and they are sequentially superimposingly transferred to the same transfer material.

In FIG. 6, reference numerals 1a to 1d denote electrostatic latent image bearing members (photosensitive drums); 19a to 19d, cleaners; 41a to 41d, image forming sections; 42a to 42d, latent image forming means; 43a to 43d, transferring discharge assemblies; 44a to 44d, primary charging assemblies; 45, a charge eliminator (destaticizer); 46, a transfer belt; 7a to 7d, developing assemblies; 48, an attraction charging assembly; 49a to 49d, separation destaticizing assemblies; 23, a fixing assembly; and 50, a delivery opening. The same members as those shown in FIGS. 2 to 4 are denoted by the same reference numerals.

In the constitution shown in FIG. 6, the first to fourth image forming sections 41a to 41d are side by side provided, and the image forming sections have electrostatic latent image bearing members used respectively exclusively therein, i.e., the photosensitive drums 1a to 1d. The photosensitive drums 1a to 1d are provided on their peripheral sides with the latent image forming means 42a to 42d, the developing assemblies 7a to 7d, the transfer discharging assemblies 43a to 43d, the cleaners 19a to 19d and the primary charging assemblies 44a to 44d, respectively.

With such construction, first, on the photosensitive drum 1a of the first image forming section 41a, for example a yellow component color latent image in an original image is formed by the latent image forming means 42a. This latent image is developed with a yellow toner of the developing apparatus 7a to form a yellow toner image as a visible image, which is then transferred to a transfer material 15 by means of the transferring discharge assembly 43a.

In the course the yellow toner image is transferred to the transfer material 15 as described above, in the second image forming section 41b a magenta component color latent image is formed on the photosensitive drum 1b, and is subsequently developed with a magenta toner of the developing apparatus 7b to form a visible image. This visible image (magenta toner image) is superimposingly transferred to the transfer material 15 on which the transfer in the first image forming section 41a has been completed, by means of the transferring discharge assembly 43b.

Subsequently, in the same manner as described above, cyan and black color toner images are formed in the third and fourth image forming sections 41c and 41d, respectively, and the cyan and black color toner images are sequentially superimposingly transferred to the same transfer material 15. Upon completion of such an image forming process, the transfer material 15 is transported to the fixing assembly 23, where the toner images on the transfer material 15 are fixed. Thus, a multi-color image is obtained on the transfer material 15. The respective photosensitive drums 1a to 1d on which the transfer has been completed are cleaned by the cleaners 19a to 19d, respectively, to remove the residual toner, and are used for the next latent image formation subsequently carried out.

In the above image forming apparatus, the transport belt 46 is used to transport the transfer material 15. As viewed in FIG. 6, the transfer material 15 is transported from the right side to the left side, and, in the course of this transport, the respective-color toner images are transferred by the aid of the transferring discharge assemblies 43a to 43d in the image forming sections 41a to 41d, respectively.

In this image forming apparatus, as a transport means for transporting the transfer material 15, a transport belt making use of a mesh made of Tetoron fiber and a transport belt making use of a thin dielectric sheet made of a polyethylene terephthalate resin, a polyimide resin or a urethane resin are used from the viewpoint of readiness in working and durability.

After the transfer material 15 has passed through the fourth image forming section 41d, a DC voltage is applied to the charge eliminator 45, whereupon the transfer material 15 is destaticized, separated from the transfer belt 46, thereafter sent into the fixing assembly 23, where the toner images are fixed, and then sent out through the delivery opening 50.

Incidentally, such a full-color image forming apparatus is so made up that a plurality of image forming sections have respectively independent electrostatic latent image bearing members and the transfer material is sent successively to the transfer zones of the respective electrostatic latent image bearing members by a belt type transport means. Instead, the apparatus may also be so made up that it has an electrostatic latent image bearing member common to the respective image forming sections and the transfer material is sent repeatedly to the transfer zone of the electrostatic latent image bearing member by a drum type transport means so that the toner images of respective colors are received there.

In the transfer belt system shown in FIG. 6, since the transfer belt has a high volume resistivity, it continues to increase charge quantity in the course the transfer is repeated several times, as in the case of color image forming apparatus. Hence, no uniform transfer can not be maintained unless the transfer electric currents are made greater successively at every transfer. However, the toner of the present invention has so good a transfer performance that the transfer performance of the toner at every transfer can be made uniform under the like transfer electric currents even if the charge of the transfer belt has increased at every repetition of transfer, so that images with a good quality and a high quality level can be obtained.

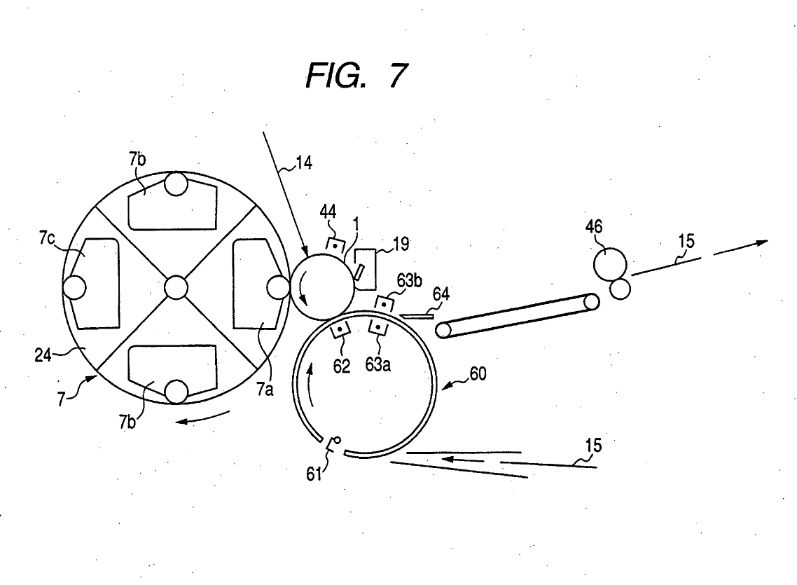

FIG. 7 further schematically illustrates the construction of another image forming apparatus practicing the image forming method of the present invention, which is as described below.

In FIG. 7, reference numeral 7 denotes a developing system; 44, a primary charging assembly; 60, a transfer drum; 61, a gripper; 62, a transfer charging assembly; 63a and 63b, separation charging assemblies; and 64, a separation guide. The same members as those shown in FIGS. 2 to 6 are denoted by the same reference numerals.

In the construction shown in FIG. 7, an electrostatic latent image formed on the photosensitive drum 1 through a suitable means (exposure 14) is rendered visible with a first toner to form a first-color toner image, by means of a first developing apparatus 7a among developing assemblies 7a to 7d attached to a developing unit 24 which is rotatable in the direction of an arrow. The first-color toner image thus formed on the photosensitive drum 1 is transferred by means of a transfer charging assembly 62 to a transfer material 15 held on the transfer drum 60 by the gripper 61. Transfer residual toner remaining on the surface of the photosensitive drum 1 after transfer is collected by a cleaner 19 having a cleaning blade coming in contact with the surface of the photosensitive drum 1, thus the photosensitive drum 1 is cleaned.

In the transfer charging assembly 62, a corona charging assembly or a contact charging assembly is used. In the case when the corona charging assembly is used in the transfer charging assembly 62, a voltage of −10 kV to +10 kV is applied, and transfer electric current is set at −500 μA to +500 μA. On the peripheral surface of the transfer drum 60, a holding member is put over. This holding member is formed of a filmlike dielectric sheet such as polyvinylidene fluoride resin film or polyethylene terephthalate film. For example, a sheet with a thickness of from 100 μm or more and 200 μm or less and a volume resistivity of from 10¹² Ωcm or more and 10¹⁴ Ωm or less is used.

Next, for the second color, the developing unit 24 is rotated, until the developing apparatus 7b faces the photosensitive drum 1. Then, the second-color electrostatic latent image formed thereon is developed with a second toner by means of the developing apparatus 7b, and the toner image thus formed is also superimposingly transferred onto the same transfer material 15 as the above.

Similar operation is also repeated for the third and fourth colors. Thus, the transfer drum 60 is rotated given times while the transfer material 15 is kept gripped thereon, so that the toner images corresponding to the number of given colors are multiple-transferred to the transfer material. Transfer electric current for electrostatic transfer may preferably be made greater in the order of first color, second color, third color and fourth color so that the toners may less remain on the photosensitive drum 1 after transfer.

The transfer material 15 on which the multiple transfer has been completed is separated from the transfer drum 60 by means of the separation charging assemblies 63a and 63b. Then the toner images held on the transfer material 15 are fixed by means of a heat-and-pressure roller fixing assembly 46, and color-additively mixed at the time of fixing, whereupon a full-color copied image is formed.

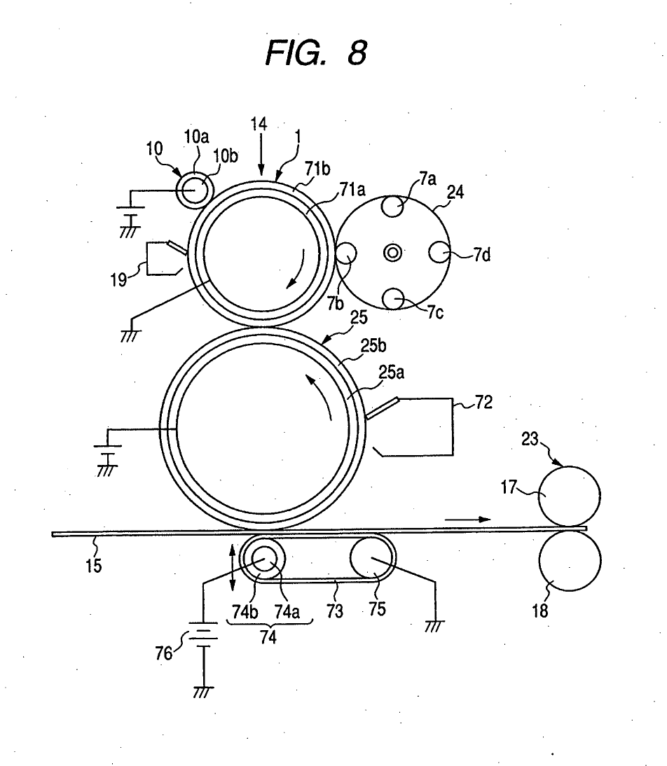

As an example of still another apparatus practicing the image forming method of the present invention, FIG. 8 schematically illustrates the construction of an image apparatus employing a transfer belt as a secondary transfer means when four-color color toner images primarily superimposingly transferred to an intermediate transfer drum are one-time transferred to a transfer material.

In the apparatus shown in FIG. 8, black, yellow, cyan and magenta color toners are put into developing assemblies 7a to 7d, respectively. Electrostatic latent images (formed by exposure 14) formed on an electrostatic latent image bearing member (photosensitive drum) 1 are developed to form toner images of respective colors on the photosensitive drum 1. The photosensitive drum 1 has a support 71a and formed thereon a photoconductive insulating material layer 71b formed of a-Se, CdS, ZnO₂, OPC, a-Si or the like, and is rotatingly driven in the direction of an arrow by means of a drive system (not shown). A photosensitive member having as a photosensitive layer 71a an amorphous silicon photosensitive layer or an organic photosensitive layer may preferably be used.

The organic photosensitive layer may be of a single-layer type in which the photosensitive layer contains a charge generating material and a charge transporting material in the same layer, or may be a function-separated photosensitive layer composed of a charge transport layer and a charge generation layer. A multi-layer type photosensitive layer comprising a conductive substrate and formed superposingly thereon the charge generation layer and then the charge transport layer in this order is one of preferred examples.

As binder resins for the organic photosensitive layer, polycarbonate resins, polyester resins or acrylic resins afford an especially good transfer performance and cleaning performance, and can not easily cause faulty cleaning, melt-adhesion of toner to the photosensitive member and filming of external additives.

The step of charging has a system making use of a corona charging assembly and being in non-contact with the photosensitive drum 1, or a contact type system making use of a roller or the like. Either system may be used. The contact type system as shown in FIG. 8 may preferably be used so as to enable efficient and uniform charging, simplify the system and make ozone less occur.

A charging roller 10 is constituted basically of a mandrel 10b at the center and a conductive elastic layer 10a that forms the periphery of the former. The charging roller 10 is kept in pressure contact with the surface of the photosensitive drum 1 at a pressing force and is rotated followingly as the photosensitive drum 1 is rotated.

As preferable process conditions when the charging roller 10 is used, they are the same as those of the apparatus shown in FIG. 3.

The toner images on the photosensitive drum 1 are transferred to an intermediate transfer drum 25 to which a voltage (e.g., plus-minus 0.1 to plus-minus 5 kV) is applied. The surface of the photosensitive drum 1 after transfer is cleaned by a cleaner 19 having a cleaning blade.

The intermediate transfer drum 25 is constituted of a support 25a and an elastic layer 25b formed thereon, and is provided in contact with the bottom part of the photosensitive drum 1, being axially supported in parallel to the photosensitive drum 1, and is rotatingly driven at the same peripheral speed as the photosensitive drum 1 and in the anti-clockwise direction as shown by an arrow.

The first-color to fourth-color toner images sequentially formed and held on the surface of the photosensitive drum 1 are, in the course where they are sequentially passed through a transfer nip where the photosensitive drum 1 and the intermediate transfer drum 25 come into contact, intermediately sequentially superimposingly transferred on (primary transfer) to the peripheral surface of the intermediate transfer drum 25 by the aid of an electric filed formed at a transfer nip region by a transfer bias applied to the intermediate transfer drum 25, thus a multiple toner image is formed thereon.

If necessary, after the multiple toner image has been transferred to the transfer material 15 in the next step, the surface of the intermediate transfer drum 25 may be cleaned by a cleaning means 72 which can come in contact with or separate from it. When any toner image(s) is/are present on the intermediate transfer drum 25, the cleaning means 72 is kept separated from the surface of the intermediate transfer drum 25 so that the toner image(s) is/are not disturbed.

A transfer means is provided in contact with the bottom part of the intermediate transfer drum 25, being axially supported in parallel to the intermediate transfer drum 25. The transfer means is, e.g., a transfer roller or a transfer belt, and is rotatingly driven at the same peripheral speed as the intermediate transfer drum 25 in the clockwise direction as shown by an arrow. The transfer means may be so provided that it comes into direct contact with the intermediate transfer drum 25, or may be so disposed that a belt or the like comes into contact with, and between, the intermediate transfer drum 25 and the transfer means.

In the case when the transfer means is the transfer roller, it is basically constituted of a mandrel at the center and a conductive elastic layer that forms the periphery of the former.

The intermediate transfer drum and the transfer roller may be formed of commonly available materials. The elastic layer of the transfer roller may be made to have a volume resistivity set smaller than the volume resistivity of the elastic layer 25b of the intermediate transfer drum 25, whereby the voltage applied to the transfer roller can be lessened, a good multiple toner image can be transferred onto the transfer material 15 and also the transfer material 15 can be prevented from being wound around the intermediate transfer drum 25. In particular, the elastic layer 25b of the intermediate transfer drum 25 may preferably have a volume resistivity at least 10 times the volume resistivity of the elastic layer of the transfer roller.

The hardness of the intermediate transfer drum and transfer roller is measured according to JIS K 6301. The intermediate transfer drum 25 used in the present invention may preferably be constituted of an elastic layer 25b having a hardness in the range of 10 degrees or more and 40 degrees or less. As for the hardness of the elastic layer of the transfer roller, the transfer roller may preferably have an elastic layer with a hardness higher than the hardness of the elastic layer 25b of the intermediate transfer drum 25 and has a value of 41 degrees or more and 80 degrees or less, in order to prevent the transfer material 15 from being wound around the intermediate transfer drum 25. If the intermediate transfer drum 25 and the transfer roller have a reverse hardness, a concave may be formed on the transfer roller side to tend to cause the transfer material 15 to wind around the intermediate transfer drum 25.

In what is shown in FIG. 8, as the above transfer means, a transfer belt 73 is provided beneath the intermediate transfer drum 25. The transfer belt 73 is stretched over two rollers, i.e., a bias roller 74 and a tension roller 75 which are provided in parallel to the axis of the intermediate transfer drum 25, and is driven by a drive means (not shown). The transfer belt 73 is so set up as to be movable in the directions of an arrow on the side of the bias roller 74 setting the tension roller 75 side as an axis so that it can come in contact with or separate from the intermediate transfer drum 25 from beneath in the directions of an arrow. To the bias roller 74, a desired secondary transfer bias is applied by a bias source 76 for secondary transfer. As for the tension roller 75, it is grounded.

Then, as the transfer belt 73, used is, e.g., a rubber belt comprising an about 300 μm thick thermosetting urethane elastomer layer in which carbon has been dispersed so as to be controlled to have a volume resistivity of 10⁸ Ωcm or more and 10¹² Ωcm or less (at the time of application of 1 kV) and on which a 20 μm thick fluororubber layer controlled to have a volume resistivity of 10¹⁵ Ωcm (at the time of application of 1 kV) is provided. It has the shape of a tube having an external size of 80 mm in peripheral length and 300 mm in width.

The transfer belt 73 described above is kept elongated by about 5% by tension applied by the aid of the above bias roller 74 and tension roller 75.

The transfer belt 73 is rotated at a speed equal to, or made different from, the peripheral speed of the intermediate transfer drum 25. The transfer material 15 is transported between the intermediate transfer drum 25 and the transfer belt 73 and simultaneously a bias with a polarity reverse to triboelectric charges the toner has is applied to the transfer belt 73 from the bias power source 76, whereby the multiple toner image on the intermediate transfer drum 25 is secondarily transferred to the surface side of the transfer material 15.

A rotating member for transfer may be made of the same material as that used in the charging roller. The transfer may preferably be performed under process conditions of a roller contact pressure of 5 g/cm or more and 500 g/cm or less and a DC voltage of plus-minus 0.2 to plus-minus 10 kV.

A conductive elastic layer 74b of the bias roller 74 is made of, e.g., an elastic material having a volume resistivity of 10⁶ Ωcm or more and 10¹⁰ Ωcm or less, such as a polyurethane, or an ethylene-propylene-diene type terpolymer (EPDM), with a conducting agent such as carbon dispersed therein. A bias is applied to its mandrel 74a from a constant voltage power source. As bias conditions, a voltage of from plus-minus 0.2 to plus-minus 10 kV is preferred.

Subsequently, the transfer material 15 is transported to a fixing assembly 23 constituted basically of a heating member 18 provided internally with a heating element such as a halogen heater and an elastic-material pressure member 17 kept in contact therewith at a pressing force, and is passed between the heating member 18 for fixing and the pressure member 17 for fixing, thus the multiple toner image is fixed by heat and pressure to the transfer material 15.

### EXAMPLES

The present invention is described below in greater detail by giving production examples and working examples, which, however, by no means limit the present invention.

### Toner Production Example 1

To 900 parts by mass of ion-exchanged water heated to 70° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) |
|---|---|
| Styrene | 80 parts |
| n-Butyl acrylate | 15 parts |
| 1,3-butanediol dimethacrylate | 0.3 part |
| Saturated polyester resin | 4.5 parts |
| (polycondensation product of propylene oxide | |
| modified bisphenol A and isophthalic acid; Tg: 65° C.; | |
| Mn: 17,000; Mw/Mn: 2.4) | |
| C.I. Pigment Blue 15:3 | 10 parts |

Meanwhile, the materials formulated as above were uniformly dispersed and mixed by means of an attritor (manufactured by Mitsui Miike Engineering Corporation) to prepare a monomer composition. This monomer composition was heated to 70° C., and 9 parts by mass of an ester wax (maximum endothermic peak in DSC measurement: 67° C.) composed chiefly of stearyl stearate was added thereto and mixed to effect dissolution. In the monomer mixture obtained, 3 parts by mass of a polymerization initiator 2,2′-azobis-2-methylbutyronitrile (10-hour half-life temperature: 67° C.) was dissolved to obtain a polymerizable monomer system.

The polymerizable monomer system was introduced into the above aqueous medium, and these were stirred at 70° C., and for 7 minutes at 10,000 rpm by means of a TK-type homomixer in an atmosphere of N₂ to carry out granulation. After the lapse of a stated time, a mixture of:

| | |
|---|---|
| styrene | 5 parts |
| salicylic acid aluminum compound | 1 part |
| (BONTRON E-88, available from | |
| Orient Chemical Industries, Ltd.); | |

was added, followed by further stirring for 1 minute at 10,000 rpm.

Thereafter, with stirring by means of a paddle stirring blade, the reaction was carried out at 70° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

The above particles were dried at 40° C. for 12 hours to obtain colored particles (toner particles) with a weight-average particle diameter of 7.6 μm.

100 parts by mass of the toner particles obtained and 0.7 part by mass of hydrophobic fine silica powder treated with silicone oil and having a BET value (specific surface area) of 200 m²/g and a primary particle diameter of 12 nm were mixed by means of Henschel mixer (manufactured by Mitsui Miike Engineering Corporation) to obtain Toner 1.

Physical properties of Toner 1 are shown in Table 1 (Table 1(A) and 1(B)).

### Toner Production Example 2

To 900 parts by mass of ion-exchanged water heated to 60° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) |
|---|---|
| Styrene | 80 parts |
| n-Butyl acrylate | 15 parts |
| Saturated polyester resin | 5 parts |
| (polycondensation product of propylene oxide | |
| modified bisphenol A and isophthalic acid; Tg: 65° C.; | |
| Mn: 17,000; Mw/Mn: 2.4) | |
| Salicylic acid aluminum compound | 1 part |
| (BONTRON E-88, available from Orient Chemical | |
| Industries, Ltd.) | |
| C.I. Pigment Blue 15:3 | 10 parts |
| Ester wax composed chiefly of behenyl behenate | 14 parts |
| (maximum endothermic peak in DSC measurement: 72° C.) | |

Meanwhile, the materials formulated as above were uniformly dispersed and mixed by means of an attritor (manufactured by Mitsui Miike Engineering Corporation) to prepare a monomer composition. This monomer composition was heated to 60° C., and 4 parts by mass of a polymerization initiator lauroyl peroxide (10-hour half-life temperature: 62° C.) was dissolved therein to obtain a polymerizable monomer system.

The polymerizable monomer system was introduced into the above aqueous medium, and these were stirred at 60° C., and for 7 minutes at 10,000 rpm by means of a TK-type homomixer in an atmosphere of N₂ to carry out granulation. After the lapse of a stated time, a mixture of:

| | |
|---|---|
| styrene | 5 parts |
| Salicylic acid aluminum compound | 1.7 parts |
| (BONTRON E-88, available from | |
| Orient Chemical Industries, Ltd.); | |

was added, followed by further stirring for 1 minute at 10,000 rpm.

Thereafter, with stirring by means of a paddle stirring blade, the reaction was carried out at 60° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

The above particles were dried at 45° C. for 12 hours to obtain colored particles (toner particles) with a weight-average particle diameter of 7.7 μm.

100 parts by mass of the toner particles obtained and 1.3 parts by mass of hydrophobic fine silica powder treated with silicone oil and having a BET value (specific surface area) of 200 m²/g and a primary particle diameter of 12 nm were mixed by means of Henschel mixer (manufactured by Mitsui Miike Engineering Corporation) to obtain Toner 2.

Physical properties of Toner 2 are shown in Table 1.

### Toner Production Example 3

To 900 parts by mass of ion-exchanged water heated to 60° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) |
|---|---|
| Styrene | 86 parts |
| n-Butyl acrylate | 14 parts |
| Divinylbenzene | 0.5 part |
| Saturated polyester resin | 5 parts |
| (polycondensation product of propylene oxide | |
| modified bisphenol A and isophthalic acid; Tg: 65° C.; | |
| Mn: 17,000; Mw/Mn: 2.4) | |
| Salicylic acid aluminum compound | 1 part |
| (BONTRON E-88, available from Orient Chemical | |
| Industries, Ltd.) | |
| C.I. Pigment Blue 15:3 | 10 parts |
| Ester wax composed chiefly of stearyl stearate | 1.5 parts |
| (maximum endothermic peak in DSC measurement: 67° C.) | |

Meanwhile, the materials formulated as above were uniformly dispersed and mixed by means of an attritor (manufactured by Mitsui Miike Engineering Corporation) to prepare a monomer composition. This monomer composition was heated to 60° C., and 4 parts by mass of a polymerization initiator lauroyl peroxide (10-hour half-life temperature: 62° C.) was dissolved therein to obtain a polymerizable monomer system.

The polymerizable monomer system was introduced into the above aqueous medium, and these were stirred at 60° C., and for 7 minutes at 10,000 rpm by means of a TK-type homomixer in an atmosphere of N₂ to carry out granulation. After the lapse of a stated time, a mixture of:

| | |
|---|---|
| toluene | 5 parts |
| Salicylic acid aluminum compound | 2 parts |
| (BONTRON E-88, available from | |
| Orient Chemical Industries, Ltd.); | |

Industries, Ltd.);

was added, followed by further stirring for 1 minute at 10,000 rpm.

Thereafter, with stirring by means of a paddle stirring blade, the reaction was carried out at 60° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

The above particles were dried at 45° C. for 12 hours to obtain colored particles (toner particles) with a weight-average particle diameter of 7.7 μm.

100 parts by mass of the toner particles obtained and 0.7 part by mass of fine titanium oxide powder having a BET value (specific surface area) of 150 m²/g and a primary particle diameter of 30 nm were mixed by means of Henschel mixer (manufactured by Mitsui Miike Engineering Corporation) to obtain Toner 3.

Physical properties of Toner 3 are shown in Table 1.

### Toner Production Example 4

To 900 parts by mass of ion-exchanged water heated to 60° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) |
|---|---|
| Styrene | 83 parts |
| n-Butyl acrylate | 17 parts |
| Saturated polyester resin | 5 parts |
| (polycondensation product of propylene oxide | |
| modified bisphenol A and isophthalic acid; Tg: 65° C.; | |
| Mn: 17,000; Mw/Mn: 2.4) | |
| C.I. Pigment Blue 15:3 | 10 parts |
| Fischer-Tropsch wax | 22 parts |
| (FT-100, available from Nippon Seiro Co., Ltd.; | |
| maximum endothermic peak in DSC measurement: 88° C.) | |

Meanwhile, the materials formulated as above were uniformly dispersed and mixed by means of an attritor (manufactured by Mitsui Miike Engineering Corporation) to prepare a monomer composition. This monomer composition was heated to 60° C., and 4 parts by mass of a polymerization initiator lauroyl peroxide (10-hour half-life temperature: 62° C.) was dissolved to obtain a polymerizable monomer system.

The polymerizable monomer system was introduced into the above aqueous medium, and these were stirred at 60° C., and for 7 minutes at 10,000 rpm by means of a TK-type homomixer in an atmosphere of N₂ to carry out granulation. After the lapse of a stated time, with stirring by means of a paddle stirring blade, the reaction was carried out at 60° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

The above particles were dried at 40° C. for 12 hours to obtain colored particles with a weight-average particle diameter of 7.7 μm.

Based on 137 parts by mass of the colored particles obtained;

| | |
|---|---|
| salicylic acid aluminum compound | 2 parts |
| (BONTRON E-88, available from | |
| Orient Chemical Industries, Ltd.); | |

was mixed therein by means of a blender, and the mixture obtained was melt-kneaded using a twin-screw extruder heated to 110° C. The kneaded product obtained and cooled was crushed by means of a hammer mill, and the crushed product was finely pulverized by means of a jet mill impact type jet mill (manufactured by Nippon Pneumatic MFG. Co., Ltd.). The finely pulverized product obtained was classified to obtain toner particles with a weight-average particle diameter of 7.7 μm.

100 parts by mass of the toner particles obtained and 0.7 part by mass of fine titanium oxide powder having a BET value (specific surface area) of 150 m²/g and a primary particle diameter of 30 nm were mixed by means of Henschel mixer (manufactured by Mitsui Miike Engineering Corporation) to obtain Toner 4.

Physical properties of Toner 4 are shown in Table 1.

### Toner Production Example 5

Toner 5 was obtained in the same manner as in Toner Production Example 1 except that, in place of 3 parts by mass of the 2,2′-azobis-2-methylbutyronitrile, t-hexyl peroxypivarate (PEROXYL PV, available from Nippon Oil & Fats Co., Ltd.) was used in an amount of 14 parts by mass.

Physical properties of Toner 5 are shown in Table 1.

### Toner Production Example 6

To 900 parts by mass of ion-exchanged water heated to 70° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) | |
|---|---|---|
| Styrene | 91 | parts |
| n-Butyl acrylate | 4 | parts |
| Divinylbenzene | 0.3 | part |
| Saturated polyester resin | 4.5 | parts |
| (polycondensation product of propylene oxide | | |
| modified bisphenol A and isophthalic acid; Tg: 65° C.; | | |
| Mn: 17,000; Mw/Mn: 2.4) | | |
| Salicylic acid aluminum compound | 1 | part |
| (BONTRON E-88, available from Orient Chemical | | |
| Industries, Ltd.) | | |
| C.I. Pigment Blue 15:3 | 10 | parts |

Meanwhile, the materials formulated as above were uniformly dispersed and mixed by means of an attritor (manufactured by Mitsui Miike Engineering Corporation) to prepare a monomer composition. This monomer composition was heated to 70° C., and 9 parts by mass of an ester wax (maximum endothermic peak in DSC measurement: 67° C.) composed chiefly of stearyl stearate was added thereto and mixed to effect dissolution. In the monomer mixture obtained, 3 parts by mass of a polymerization initiator 2,2′-azobis-2-methylbutyronitrile (10-hour half-life temperature: 67° C.) was dissolved to obtain a polymerizable monomer system.

The polymerizable monomer system was introduced into the above aqueous medium, and these were stirred at 70° C., and for 7 minutes at 10,000 rpm by means of a TK-type homomixer in an atmosphere of N₂ to carry out granulation. After the lapse of a stated time;

| | |
|---|---|
| styrene | 5 parts; |

was added, followed by further stirring for 1 minute at 10,000 rpm.

Thereafter, with stirring by means of a paddle stirring blade, the reaction was carried out at 70° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

The above particles were dried at 40° C. for 12 hours to obtain colored particles (toner particles) with a weight-average particle diameter of 7.6 μm.

100 parts by mass of the toner particles obtained and 1.3 parts by mass of hydrophobic fine silica powder treated with silicone oil and having a BET value (specific surface area) of 200 m²/g and a primary particle diameter of 12 nm were mixed by means of Henschel mixer (manufactured by Mitsui Miike Engineering Corporation) to obtain Toner 6.

Physical properties of Toner 6 are shown in Table 1.

### Toner Production Example 7

(7-1. Synthesis of Toner Binder 7)

Into a reaction tank provided with a cooling tube, a stirrer and a nitrogen feed tube, 724 parts by mass of bisphenol-A ethylene oxide 2-mole addition product, 276 parts by mass of isophthalic acid and 2 parts by mass of dibutyltin oxide were introduced, and the reaction was carried out at 230° C. for 8 hours under normal pressure. Thereafter, the reaction was further carried out for 5 hours under a reduced pressure of 10 to 15 mmHg. The reaction product obtained was cooled to 160° C., and 32 parts by mass of phthalic anhydride was added, where the reaction was carried out for 2 hours. Further, this was cooled to 80° C., and then allowed to react for 2 hours with 188 parts by mass of isophorone diisocyanate in ethyl acetate to obtain an isocyanate-containing prepolymer (1). Next, 267 parts by mass of this prepolymer (1) and 14 parts by mass of isophorone diamine were allowed to react at 50° C. for 2 hours to obtain a urea modified polyester resin (1) with a weight-average molecular weight of 64,000.

Like the foregoing, 724 parts by mass of bisphenol-A ethylene oxide 2-mole addition product and 276 parts by mass of terephthalic acid were subjected to polycondensation at 230° C. for 8 hours under normal pressure. Then, the reaction was further carried out for 5 hours under a reduced pressure of 10 to 15 mmHg to obtain an unmodified polyester resin (a) with a peak molecular weight of 5,000.

200 parts by mass of the urea modified polyester resin (1) and 800 parts by mass of the unmodified polyester resin (a) were dissolved and mixed in 2,000 parts by mass of an ethyl acetate/ethyl methyl ketone (MEK) (1/1) mixed solvent to obtain an ethyl acetate/MEK solution of a toner binder (7). A portion thereof was dried under reduced pressure to isolate the toner binder (7). Its Tg was 62° C.

7-2. Production of Toner Particles

Into a beaker, 300 parts by mass of the above ethyl acetate/MEK solution of the toner binder (7), 9 parts by mass of an ester wax composed chiefly of stearyl stearate, 1 part of salicylic acid aluminum compound (BONTRON E-88, available from Orient Chemical Industries, Ltd.) and 6 parts by mass of C.I. Pigment Blue 15:3 as a cyan pigment were introduced, and these were stirred at 60° C. and at 12,000 rpm by means of a TK type homomixer to effect uniform dissolution and dispersion to prepare a toner material fluid.

Into a beaker, 706 parts by mass of ion-exchanged water, 294 parts by mass of a hydroxylapatite 10% suspension (SUPATITE 10, available from Nippon Chemical Industrial Co., Ltd.) and 0.2 part by mass of sodium dodecylbenzenesulfonate were introduced, and were uniformly dissolved. Then, the solution obtained was heated to 60° C., and, with stirring at 12,000 rpm by means of a TK type homomixer, the above toner material fluid was introduced into it, and these were stirred for 10 minutes. Then, the liquid mixture obtained was moved to a Kolben (flask) provided with a stirring rod and a thermometer, and then heated to 98° C. to remove the solvent, followed by filtration, washing and then drying, and further followed by air classification to obtain a colored powder (toner particles) with a weight-average particle diameter of 6.4 μm.

100 parts by mass of the toner particles obtained and 2.5 parts by mass of hydrophobic fine silica powder treated with silicone oil and having a BET value (specific surface area) of 200 m²/g and a primary particle diameter of 12 nm were mixed by means of a Henschel mixer (manufactured by Mitsui Miike Engineering Corporation) to obtain Toner 7.

Physical properties of Toner 7 are shown in Table 1.

### Toner Production Example 8

To 900 parts by mass of ion-exchanged water heated to 73° C., 3 parts by mass of tricalcium phosphate was added, and these were stirred at 10,000 rpm using a TK-type homomixer (manufactured by Tokushu Kika Kogyo Co., Ltd.) to obtain an aqueous medium.

| | (by mass) |
|---|---|
| Styrene | 80 parts |
| n-Butyl acrylate | 20 parts |
| Divinylbenzene | 0.5 part |
| Ethylene glycol diacrylate | 2.1 parts |
| Saturated polyester resin | 1.0 part |
| (polycondensation product of propylene oxide | |
| modified bisphenol A and isophthalic acid; | |
| Tg: 62° C.; Mn: 17,000; Mw/Mn: 2.4) | |
| Salicylic acid aluminum compound | 1 part |
| (BONTRON E-88, available from Orient Chemical | |
| Industries, Ltd.) | |
| C.I. Pigment Blue 15:3 | 10 parts |

Meanwhile, the materials formulated as above were uniformly dispersed and mixed by means of an attritor (manufactured by Mitsui Miike Engineering Corporation) to prepare a monomer composition. This monomer composition was heated to 73° C., and 0.7 part by mass of an ester wax (maximum endothermic peak in DSC measurement: 67° C.) composed chiefly of stearyl stearate was added thereto and mixed to effect dissolution. In the monomer mixture obtained, 2 parts by mass of a polymerization initiator 2,2′-azobis-2-methylbutyronitrile was dissolved to obtain a polymerizable monomer system.

The polymerizable monomer system was introduced into the above aqueous medium, and these were stirred at 73° C., and for 7 minutes at 10,000 rpm by means of a TK-type homomixer in an atmosphere of N₂ to carry out granulation. Thereafter, with stirring by means of a paddle stirring blade, the reaction was carried out at 73° C. for 6 hours. Thereafter, the liquid temperature was raised to 80° C., and the stirring was continued for further 4 hours. After the reaction was completed, to the suspension cooled to room temperature (25° C.), hydrochloric acid was added to dissolve the tricalcium phosphate, followed by filtration and then washing with water to obtain wet colored particles.

Next, the above particles were dried at 40° C. for 12 hours to obtain colored particles (toner particles) with a weight-average particle diameter of 7.0 μm.

100 parts by mass of the toner particles obtained and 0.7 part by mass of fine titanium oxide powder having a BET value (specific surface area) of 150 m²/g and a primary particle diameter of 30 nm were mixed by means of Henschel mixer (manufactured by Mitsui Miike Engineering Corporation) to obtain Toner 8.

Physical properties of Toner 8 are shown in Table 1.

### Toner Production Example 9

Into a reaction tank provided with a cooling tube, a stirrer and a nitrogen feed tube, 704 parts by mass of bisphenol-A ethylene oxide 2-mole addition product, 296 parts by mass of isophthalic acid and 2 parts by mass of dibutyltin oxide were introduced, and the reaction was carried out at 230° C. for 5 hours under normal pressure. Thereafter, the reaction was further carried out for 5 hours under a reduced pressure of 10 to 15 mmHg. The reaction product obtained was cooled to 160° C., and 30 parts by mass of phthalic anhydride was added, where the reaction was carried out for 2 hours. Further, this was cooled to 80° C., and then allowed to react for 2 hours with 188 parts by mass of isophorone diisocyanate in ethyl acetate to obtain an isocyanate-containing prepolymer (2). Next, 267 parts by mass of this prepolymer (2) and 14 parts by mass of isophorone diamine were allowed to react at 60° C. for 2 hours to obtain a urea modified polyester resin (2) with a weight-average molecular weight of 59,000. Its Tg was 60° C.

100 parts by mass of the urea modified polyester resin (2) was dissolved and mixed in 200 parts by mass of an ethyl acetate/ethyl methyl ketone (MEK) (1/1) mixed solvent.

In the solution obtained, 23 parts by mass of an ester wax composed chiefly of behenyl behenate and 6 parts by mass of C.I. Pigment Blue 15:3 as a cyan pigment were introduced, and these were stirred at 70° C. and at 12,000 rpm by means of a TK type homomixer to effect uniform dissolution and dispersion to prepare a toner material fluid.

Into a beaker, 706 parts by mass of ion-exchanged water, 294 parts by mass of a hydroxylapatite 10% suspension (SUPATITE 10, available from Nippon Chemical Industrial Co., Ltd.) and 0.2 part by mass of sodium dodecylbenzenesulfonate were introduced, and were uniformly dissolved. Then, the solution obtained was heated to 73° C., and, with stirring at 12,000 rpm by means of a TK type homomixer, the above toner material fluid was introduced into it, and these were stirred for 10 minutes. Then, the liquid mixture obtained was moved to a Kolben (flask) provided with a stirring rod and a thermometer, and then heated to 98° C. to remove the solvent, followed by filtration, washing and then drying, and further followed by air classification to obtain a colored powder (toner particles) with a weight-average particle diameter of 6.0 μm.

100 parts by mass of the toner particles obtained and 0.4 part by mass of hydrophobic fine silica powder treated with silicone oil and having a BET value (specific surface area) of 200 m²/g and a primary particle diameter of 12 nm were mixed by means of a Henschel mixer (manufactured by Mitsui Miike Engineering Corporation) to obtain Toner 9.

Physical properties of Toner 9 are shown in Table 1(A) and 1(B).

TABLE 1(A)

| | | Toner formulation | | | |
|---|---|---|---|---|---|
| | | Release agent | | External additive | |
| | | | Amount based | | Amount based |
| | | | on 100 parts | | on 100 arts |
| | | | of brinder | | of toner |
| | Binder resin | | resin | | particles |
| | chief component | Type | (pbw) | Type | (pbw) |
| Toner 1 | Styrene-Acryl resin | Wax 1 | 9.0 | Hydrophobic silica | 0.7 |
| Toner 2 | Styrene-Acryl resin | Wax 2 | 14.0 | Hydrophobic silica | 1.3 |
| Toner 3 | Styrene-Acryl resin | Wax 1 | 1.5 | Untreated Ti dioxide | 0.7 |
| Toner 4 | Styrene-Acryl resin | Wax 3 | 22.0 | Hydrophobic silica | 0.7 |
| Toner 5 | Styrene-Acryl resin | Wax 1 | 9.0 | Hydrophobic silica | 0.7 |
| Toner 6 | Styrene-Acryl resin | Wax 1 | 9.0 | Hydrophobic silica | 1.3 |
| Toner 7 | Polyester | Wax 1 | 9.0 | Hydrophobic silica | 2.5 |
| Toner 8 | Styrene-Acryl resin | Wax 1 | 0.1 | Untreated Ti dioxide | 0.7 |
| Toner 9 | Polyester | Wax 2 | 23.0 | Hydrophobic silica | 0.4 |

Wax 1: Ester wax (maximum endothermic peak: 67° C.) composed chiefly of stearyl stearate.
Wax 2: Ester wax (maximum endothermic peak: 72° C.) composed chiefly of behenyl behenate.
Wax 3: Fischer Tropsch wax (maximum endothermic peak: 88° C.).

TABLE 1(B)

| | Toner physical properties | | | | | | | |
|---|---|---|---|---|---|---|---|---|
| | Storage | Loss | Loss tangent (tanδ) | | | | | |
| | elastic | elastic | Tempera- | Tempera- | Tempera- | | Weight- | |
| | modulus | modulus | ture of | ture of | ture of | | average | |
| | at 140° C. | at 140° C. | maximum | minimum | maximum | Average | particle | |
| | G′ (140° C.) | G″ (140° C.) | value 1 | value 1 | value 2 | circu- | diameter | Tg |
| | (dN/m²) | (dN/m²) | (° C.) | (° C.) | (° C.) | larity | (μm) | (° C.) |
| Toner 1 | 7.0 × 10³ | 1.1 × 10⁴ | 76 | 96 | 160 | 0.982 | 7.6 | 63 |
| Toner 2 | 2.6 × 10⁴ | 4.0 × 10⁴ | 77 | 96 | 157 | 0.984 | 7.6 | 64 |
| Toner 3 | 1.2 × 10⁵ | 1.8 × 10⁵ | 80 | 108 | 192 | 0.985 | 7.7 | 67 |
| Toner 4 | 2.1 × 10⁴ | 2.8 × 10⁴ | 72 | 87 | 141 | 0.952 | 7.7 | 60 |
| Toner 5 | 9.7 × 10³ | 1.2 × 10⁴ | 77 | 92 | 143 | 0.985 | 7.5 | 63 |
| Toner 6 | 8.8 × 10⁴ | 3.3 × 10⁵ | 103 | 113 | None | 0.977 | 7.6 | 90 |
| Toner 7 | 9.1 × 10³ | 6.7 × 10³ | 74 | 96 | 147 | 0.988 | 6.3 | 60 |
| Toner 8 | 1.0 × 10³ | 1.0 × 10³ | 66 | 81 | None | 0.964 | 7.0 | 53 |
| Toner 9 | 4.2 × 10⁴ | 4.0 × 10⁴ | 72 | 111 | None | 0.955 | 5.9 | 59 |

### Examples 1 to 5 & Comparative Examples 1 to 4

Image Evaluation

Using Toner 1 to Toner 9 obtained, images were evaluated according to the following methods.

An altered machine of a commercially available color laser printer LBP-2410 (manufactured by CANON INC.) was used as the image forming apparatus, and evaluation was made in an environment of 23° C./50% RH.

Alteration points of the evaluation machine are as follows:

(1) Its software was so altered that a monochromatic printing mode which can only be taken by a black cartridge was also able to be taken by different-color cartridges.

(2) The software was so altered that fixing speed was changeable to any desired values.

Image formation speeds (developing roller rotational speed, developing drum rotational speed and so forth) were not changed.

Cyan cartridges were used as cartridges used for evaluation. More specifically, from commercially available cartridges, toners held therein were removed, and, after their interiors were cleaned by air blowing, 160 g each of Toners 1 to 9 were put into them to make evaluation. Incidentally, into the magenta station, yellow station and black station of the evaluation machine, the magenta cartridge, yellow cartridge and black cartridge each toner run-short detecting mechanism of which was set ineffective were inserted after the toners held were removed therefrom, where the evaluation was made.

As transfer materials, the following five types were used.

Transfer Material 1: letter-size XEROX 4024 Sheet (plain paper available from Xerox Corporation; basis weight: 75 g/m²).

Transfer Material 2: letter-size HP COLOR LASER Sheet (color copying machine paper available from Hewlet Packard Co.; basis weight: 105 g/m²).

Transfer Material 3: letter-size FOX RIVER BOND Sheet (bond paper available from Fox river Co.; basis weight: 90 g/m²)

Transfer Material 4: letter-size UNION CAMP GREAT WHITE MULTI-PURPOSE Sheet (regenerated paper available from Union Camp Co.; basis weight: 75 g/m²).

Transfer Material 5: A4-size SAN-ICHI HAIFUKU-JIRUSI Sheet (neutral) (plain paper available from San-ich Haifuku-Jirushi K.K.; basis weight: 70 g/m²).

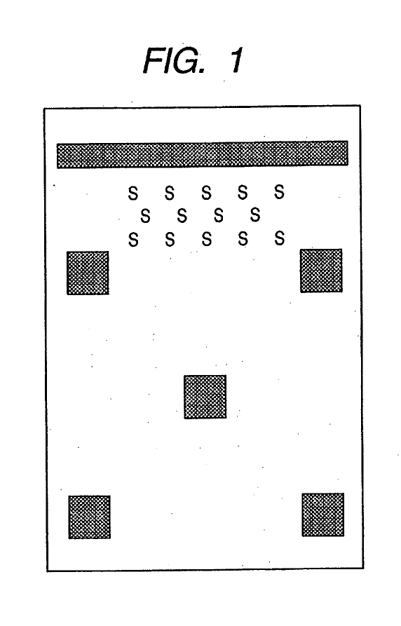

Setting each sheet of the above five types of transfer materials, five sheets in total, as one set, a print image as shown in FIG. 1, having a print percentage of 4%, was continuously printed on 1,000 sets. In any sets, image formation speed was set to the speed in the plain-paper mode.

As to the fixing speed, it was set to 190 mm/sec in respect of all the transfer materials.

Using images on the first set, the 100th set, the 500th set and the 1,000th set, the images were evaluated according to the following evaluation criteria. The results of evaluation are shown in Table 2.

Anti-Offset Properties:

Anti-offset properties were evaluated using evaluation images on Transfer Material 1.

Whether or not the images at the all-solid band area and letter S areas shown in FIG. 1 were seen on the transfer material correspondingly to the fixing film cycle (i.e., whether or not the offset occurred) was visually observed to make evaluation according to the following criteria.

A: No offset is seen to have occurred.

B: No offset is seen at the all-solid band area, but offset is seen at the letter S areas.

C: Offset is seen at the letter S areas, and offset is somewhat seen also at the all-solid band area.

D: Offset is seen at both the all-solid band area and the letter S areas.

Image Gloss:

Image gloss was evaluated using evaluation images on Transfer Materials 1 to 5.

In respect of five spots of solid-image areas shown in FIG. 1, the glossiness of images was measured with a gloss meter PG-3G (manufactured by Nippon Denshoku Kogyo K.K.), and an average value thereof was regarded as the image glossiness of the transferred images. The angle of incidence was set to 75 degrees.

The glossiness was measured on all images of the first set to determine the image glossiness average value and standard deviation in the first set.

Like measurement was also made on the 100th set, the 500th set and the 1,000th set to determine the image glossiness average value and standard deviation in each set.

Image Rub Resistance:

Image rub resistance was evaluated using evaluation images on Transfer Material 5.

In respect of the five spots of solid-image areas shown in FIG. 1, images were rubbed five times with Silbon paper to which a load of 50 g/cm² was applied. An arithmetic mean value of the rates of image density decrease after the rubbing was found to make evaluation according to the following criteria.

Incidentally, image density was measured with “Macbeth Reflection Densitometer” (manufactured by Macbeth Co.).

A: The rate of density decrease is less than 2%.

B: The rate of density decrease is 2% or more to less than 5%.

C: The rate of density decrease is 5% or more to less than 10%.

D: The rate of density decrease is 10% or more

TABLE 2

| | | | First | 100th | 500th | 1,000th |
|---|---|---|---|---|---|---|
| | | Evaluation items | set | set | set | set |
| Ex- | | | | | | |
| ample: | | | | | | |
| 1 | Toner 1 | Anti-offset properties: | A | A | A | A |
| | | Image gloss: | | | | |
| | | Average value | 13.2 | 12.9 | 13.1 | 13.3 |
| | | Standard deviation | 1.90 | 1.99 | 2.08 | 2.19 |
| | | Image rub resistance: | A | A | A | A |
| 2 | Toner 2 | Anti-offset properties: | A | A | A | A |
| | | Image gloss: | | | | |
| | | Average value | 13.1 | 12.8 | 13.0 | 12.9 |
| | | Standard deviation | 1.91 | 1.99 | 2.22 | 2.66 |
| | | Image rub resistance: | A | A | A | A |
| 3 | Toner 3 | Anti-offset properties: | A | A | A | B |
| | | Image gloss: | | | | |
| | | Average value | 13.1 | 12.6 | 12.0 | 12.4 |
| | | Standard deviation | 1.89 | 1.94 | 2.31 | 2.74 |
| | | Image rub resistance: | A | A | A | B |
| 4 | Toner 4 | Anti-offset properties: | A | A | B | B |
| | | Image gloss: | | | | |
| | | Average value | 13.1 | 12.6 | 12.4 | 12.3 |
| | | Standard deviation | 1.92 | 1.99 | 2.44 | 2.81 |
| | | Image rub resistance: | A | A | B | B |
| 5 | Toner 5 | Anti-offset properties: | A | A | A | A |
| | | Image gloss: | | | | |
| | | Average value | 13.2 | 13.1 | 12.9 | 13.0 |
| | | Standard deviation | 1.92 | 2.00 | 2.04 | 2.15 |
| | | Image rub resistance: | A | A | A | A |
| Com- | | | | | | |
| para- | | | | | | |
| tive | | | | | | |
| Ex- | | | | | | |
| ample: | | | | | | |
| 1 | Toner 6 | Anti-offset properties: | A | A | B | B |
| | | Image gloss: | | | | |
| | | Average value | 13.3 | 13.1 | 11.4 | 10.8 |
| | | Standard deviation | 2.01 | 3.08 | 3.33 | 3.46 |
| | | Image rub resistance: | B | B | D | D |
| 2 | Toner 7 | Anti-offset properties: | A | A | A | B |
| | | Image gloss: | | | | |
| | | Average value | 13.3 | 13.4 | 11.1 | 10.8 |
| | | Standard deviation | 2.64 | 2.97 | 3.24 | 3.37 |
| | | Image rub resistance: | A | A | B | B |
| 3 | Toner 8 | Anti-offset properties: | C | D | D | D |
| | | Image gloss: | | | | |
| | | Average value | 13.1 | 13.2 | 13.3 | 12.8 |
| | | Standard deviation | 1.91 | 2.11 | 2.69 | 3.33 |
| | | Image rub resistance: | A | A | A | A |
| 4 | Toner 9 | Anti-offset properties: | A | A | B | B |
| | | Image gloss: | | | | |
| | | Average value | 13.2 | 13.0 | 11.8 | 10.4 |
| | | Standard deviation | 2.66 | 3.03 | 3.16 | 3.55 |
| | | Image rub resistance: | B | C | D | D |

This application claims priority from Japanese Patent Application No. 2005-017777 filed on Jan. 26, 2005, which is hereby incorporated by reference herein.

What is claimed is:

1. A toner comprising toner particles containing at least a binder resin, a colorant and a release agent;
said toner having a loss tangent (tan δ) which has a minimum value 1 and a maximum value 1 at from 70° C. or more to less than 110° C. and has a maximum value 2 at from 140° C. or more to less than 200° C.;
said toner having a loss elastic modulus at 140° C., G″(140° C.), which is:
1.0×10⁴ dN/m²≦G″(140° C.)≦2.0×10⁵ dN/m²; and
said binder resin being chiefly composed of a vinyl type copolymer.

2. The toner according to claim 1, wherein, in regard to the loss tangent of said toner, the temperature giving the minimum value 1 is higher than the temperature giving the maximum value 1, where the minimum value 1 is in the temperature range of from 80° C. or more to less than 110° C. and the maximum value 1 is in the temperature range of from 70° C. or more to less than 100° C.

3. The toner according to claim 1, which has an average circularity S of:
0.960≦S≦0.995.

4. The toner according to claim 1, wherein said release agent is in a content A of:
2 parts by mass≦A≦20 parts by mass; based on 100 parts by mass of the binder resin.

5. The toner according to claim 1, wherein said toner particles are formed in water.

6. An image forming method comprising:
a charging step of charging an electrostatic latent image bearing member electrostatically by using a charging member to which a voltage is kept applied from the outside;
a latent image forming step of forming an electrostatic latent image on the electrostatic latent image bearing member thus charged;
a toner layer forming step of controlling a toner layer on a toner bearing member by means of a toner layer control member;
a developing step of developing the electrostatic latent image by the toner layer held on the surface of the toner bearing member, to form a toner image on the electrostatic latent image bearing member;
a transfer step of transferring the toner image to a transfer material via, or not via, an intermediate transfer member; and
a fixing step of fixing the toner image held on the transfer material;
said toner comprising toner particles containing at least a binder resin, a colorant and a release agent;
said toner having a loss tangent (tan δ) which has a minimum value 1 and a maximum value 1 at from 70° C. or more to less than 110° C. and has a maximum value 2 at from 140° C. or more to less than 200° C.;
said toner having a loss elastic modulus at 140° C., G″(140° C.), which is:
1.0×10⁴ dN/m²≦G″(140° C.)≦2.0×10⁵ dN/m²; and
said binder resin being chiefly composed of a vinyl type copolymer.

7. A process cartridge used in an image forming method making use of a toner;
said toner comprising toner particles containing at least a binder resin, a colorant and a release agent;
said toner having a loss tangent (tan δ) which has a minimum value 1 and a maximum value 1 at from 70° C. or more to less than 110° C. and has a maximum value 2 at from 140° C. or more to less than 200° C.;
said toner having a loss elastic modulus at 140° C., G″(140° C.), which is:
1.0×10⁴ dN/m²≦G″(140° C.)≦2.0×10⁵ dN/m²; and
said binder resin being chiefly composed of a vinyl type copolymer.
